(19) United States
(12) Patent Application Publication
(10) Pub. No.: US 2022/0318749 A1
(43) Pub. Date: Oct. 6, 2022

(54) COMPUTER-READABLE RECORDING MEDIUM STORING ROUTE CHANGE PROGRAM, ROUTE CHANGE METHOD AND INFORMATION PROCESSING APPARATUS

(71) Applicant: FUJITSU LIMITED, Kawasaki-shi (JP)

(72) Inventor: SHINGO TOKUNAGA, Kawasaki (JP)

(73) Assignee: FUJITSU LIMITED, Kawasaki-shi (JP)

(21) Appl. No.: 17/580,697

(22) Filed: Jan. 21, 2022

(30) Foreign Application Priority Data
Mar. 31, 2021 (JP) 2021-061770

(51) Int. Cl. G06Q 10/08; G06Q 10/04; G06Q 10/06

(52) U.S. Cl. CPC G06Q 10/08355; G06Q 10/047; G06Q 10/0833; G06Q 10/06315

(57) ABSTRACT

A route change program includes steps of detecting to change a moving route that passes through two or more destinations planned to be visited by each mobile body, of a plurality of mobile bodies that visits a plurality of destinations in a distributed manner, when detecting to change the moving route of the each mobile body, acquiring a remaining time to when the each mobile body visits, or a remaining time to when the each mobile body departs, after a visit, one destination unvisited by any of the mobile body, determining a destination as a target that changes a visit plan on a basis of the acquired remaining time, and changing the moving route of the each mobile body on a basis of the determined destination.

### CROSS-REFERENCE TO RELATED APPLICATION

This application is based upon and claims the benefit of priority of the prior Japanese Patent Application No. 2021-61770, filed on Mar. 31, 2021, the entire contents of which are incorporated herein by reference.

### FIELD

The present embodiment discussed herein is related to a change program and a change method for moving route, and an information processing apparatus.

### BACKGROUND

Conventionally, there is a technique of predetermining a moving route of a mobile body that visits a plurality of destinations. For example, in a delivery business, there is a technique for determining a moving route of a delivery vehicle in advance before departure of the delivery vehicle while considering viewpoints such as delivery cost and customer's request for a delivery time frame. A problem of determining a moving route is a type of combinatorial optimization problems.

As an existing technique, for example, in a case where an additional order is placed after a delivery plan is drawn up and a delivery operation of each vehicle is started, there is a technique for determining a target vehicle to which a delivery operation is added regarding the additional order according to the delivery plan, or the delivery plan and a progress status of the delivery operation of each vehicle. Furthermore, for example, there is a technique for searching for a delivery plan capable of dispatching a group of vehicles for delivery with a minimum number of vehicles with load capacity and a minimum total mileage within a period to a group of delivery destinations.

Japanese Laid-open Patent Publication No. 2003-002444 and Japanese Laid-open Patent Publication No. 2001-315918 are disclosed as related art.

### SUMMARY

According to an aspect of the embodiments, a non-transitory computer-readable recording medium storing a moving route change program for causing a computer to execute a process including: detecting to change a moving route that passes through two or more destinations planned to be visited by each mobile body, of a plurality of mobile bodies that visits a plurality of destinations in a distributed manner; when detecting to change the moving route of the each mobile body, acquiring a remaining time to when the each mobile body visits, or a remaining time to when the each mobile body departs, after a visit, one destination unvisited by the each mobile body which exists on the moving route of the each mobile body; determining a destination as a target that changes a visit plan, of destinations unvisited by any mobile body of the plurality of mobile bodies, on a basis of the acquired remaining time; and changing the moving route of the each mobile body on a basis of the determined destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a change method according to an embodiment;

FIG. 2 is an explanatory diagram illustrating one example of an information processing system 200;

FIG. 3 is an explanatory diagram illustrating one example of moving routes;

FIG. 4 is a block diagram illustrating a hardware configuration example of an information processing apparatus 100;

FIG. 5 is an explanatory diagram illustrating one example of stored content in a performance information management table 500;

FIG. 6 is an explanatory diagram illustrating one example of stored content in a mobile body information management table 600;

FIG. 7 is a block diagram illustrating a hardware configuration example of an on-board apparatus 204;

FIG. 8 is a block diagram illustrating a functional configuration example of the information processing apparatus 100;

FIG. 9 is a block diagram illustrating a specific functional configuration example of the information processing apparatus 100;

FIG. 10 is an explanatory diagram (part 1) illustrating a first operation example of the information processing apparatus 100;

FIG. 11 is an explanatory diagram (part 2) illustrating the first operation example of the information processing apparatus 100;

FIG. 12 is an explanatory diagram (part 3) illustrating the first operation example of the information processing apparatus 100;

FIG. 13 is an explanatory diagram (part 4) illustrating the first operation example of the information processing apparatus 100;

FIG. 14 is an explanatory diagram (part 5) illustrating the first operation example of the information processing apparatus 100;

FIG. 15 is an explanatory diagram (part 6) illustrating the first operation example of the information processing apparatus 100;

FIG. 16 is an explanatory diagram (part 7) illustrating the first operation example of the information processing apparatus 100;

FIG. 17 is a flowchart illustrating one example of an overall processing procedure in the first operation example;

FIG. 18 is a flowchart illustrating one example of a replanning processing procedure in the first operation example;

FIG. 19 is an explanatory diagram (part 1) illustrating a second operation example of the information processing apparatus 100;

FIG. 20 is an explanatory diagram (part 2) illustrating the second operation example of the information processing apparatus 100;

FIG. 21 is a flowchart illustrating one example of an overall processing procedure in the second operation example; and

FIG. 22 is a flowchart illustrating one example of a replanning processing procedure in the second operation example.

### DESCRIPTION OF EMBODIMENTS

In the existing technique, it is difficult to change the moving route while the mobile body is moving. For example, even during the change of the moving route, the mobile body continues to move and a visiting status to the destinations continues to change, so that the changed moving route may not be an effective moving route.

In one aspect, an object of the present embodiment is to enable a moving route to be appropriately changed in consideration of a moving status of a mobile body.

Hereinafter, an embodiment of a change program, a change method, and an information processing apparatus according to the present embodiment will be described with reference to the drawings.

(Example of Change Method According to Embodiment)

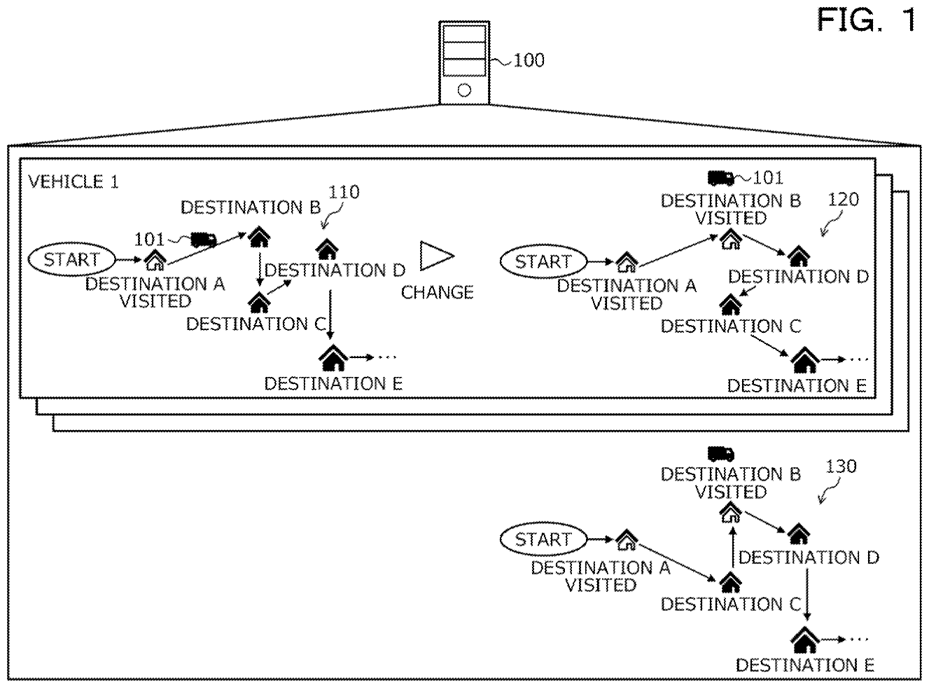

FIG. 1 is an explanatory diagram illustrating an example of a change method according to an embodiment. An information processing apparatus 100 is a computer for appropriately changing a moving route of each of a plurality of mobile bodies that visits a plurality of destinations in a distributed manner.

Conventionally, the moving route of each mobile body may be determined before the departure of a plurality of mobile bodies. For example, in a delivery business, a moving route of each delivery vehicle may be determined in advance before the departure of a plurality of delivery vehicles while considering viewpoints such as the number of delivery vehicles, the delivery cost, and customer's request for a delivery time frame, and an overall delivery plan may be planned. The delivery cost is, for example, fuel cost, running time, mileage, displacement, or the like. The delivery cost may be, for example, a difficulty in satisfying the customer's request regarding the delivery time frame.

A problem of determining a moving route is a type of combinatorial optimization problems. For the combinatorial optimization problems, for example, a mathematical optimization method such as simulated annealing (SA), genetic algorithms (GA), or tabu search is applied.

In the meantime, there is a request to correct the moving route of each mobile body during the movement of the plurality of mobile bodies after the departure of the plurality of mobile bodies. For example, a case of desiring correction of the moving route of each delivery vehicle during the movement of the plurality of delivery vehicles after the departure of the plurality of delivery vehicles is conceivable.

Specifically, a case of desiring correction of the moving route of each delivery vehicle due to a change in road conditions such as occurrence of a traffic jam, occurrence of a traffic accident, start of road construction, or start of street closure, is conceivable. Furthermore, specifically, a case of desiring correction of the moving route of each delivery vehicle due to a change in delivery status such as adding a new delivery destination, requesting redelivery by the customer, specifying the delivery time frame by the customer, or changing the delivery time by the customer, is conceivable.

However, conventionally, it has been difficult to change the moving route of each mobile body during the movement of the plurality of mobile bodies. For example, even during execution of determination processing of determining a new moving route of each mobile body, each mobile body keeps moving, and the visiting status to each destination keeps changing. Therefore, the new moving route of each mobile body may not become an effective moving route at the time when the new moving route of each mobile body has been determined.

In particular, in a case of determining the new moving route of each mobile body by a mathematical optimization method, the time required for the determination processing may increase. For example, the more destinations there are or the more constraints there are related to the delivery time frame or the like, the more likely it is that the time required for the determination processing will increase. Then, as the time required increases, the probability that the new moving route of each mobile body does not become an effective moving route tends to increase.

Therefore, in the present embodiment, a change method capable of appropriately changing a moving route of each mobile body of a plurality of mobile bodies by narrowing down destinations for which a visit plan is to be changed in consideration of a moving status of each mobile body of the plurality of mobile bodies.

In FIG. 1, a plurality of mobile bodies 101 is present. In the example of FIG. 1, the mobile body 101 is specifically a vehicle i or the like. i is an integer of 1 or larger. Furthermore, there is a plurality of destinations to be visited by the plurality of mobile bodies 101 in a distributed manner. In the example of FIG. 1, there are a destination A, a destination B, a destination C, a destination D, a destination E, and the like.

It is assumed that a moving route of each mobile body 101 is determined before the start of movement of the plurality of mobile bodies 101. The moving route is formed such that the mobile body 101 passes through two or more destinations planned to be visited, for example. Specifically, the moving route of the vehicle 1 is, for example, “the destination A->the destination B->the destination C->the destination D->the destination E-> . . . ” indicated by reference numeral 110. It is assumed that each mobile body 101 starts the movement along the determined moving route of the mobile body 101.

(1-1) The information processing apparatus 100 detects that the moving route of each mobile body 101 should be changed. As an event to change the moving route (corresponding to a change trigger to be described below), for example, the information processing apparatus 100 detects that it is favorable to change the moving route of each mobile body 101 due to a change in road condition, a change in delivery status, or the like after the start of movement of the plurality of mobile bodies 101. As a result, the information processing apparatus 100 can start change processing of changing the moving route of each mobile body 101 at appropriate times.

(1-2) When detecting to change the moving route of each mobile body 101, the information processing apparatus 100 acquires a remaining time to when each mobile body 101 departs, after a visit, one destination of unvisited destinations by the mobile body 101, the unvisited destinations existing on the moving route of the mobile body 101. The one destination is, for example, the destination planned to be visited next by the mobile body 101. The information processing apparatus 100 acquires the remaining time to when each mobile body 101 departs, after a visit, the destination planned to be visited next by the mobile body 101, the destination existing on the moving route of the mobile body 101, for example.

Specifically, the information processing apparatus 100 calculates the remaining time to when each mobile body 101 departs, after a visit, the destination planned to be visited next on the basis of an average speed, an average staying time, and the like of each mobile body 101. In the example of FIG. 1, the information processing apparatus 100 calculates the remaining time to when the vehicle 1 departs, after a visit, the destination B planned to be visited next by the vehicle 1 on the basis of the average speed, the average staying time, and the like of the vehicle 1. Thereby, the information processing apparatus 100 can obtain information that serves as a guideline for narrowing down the destinations for which the visit plan is to be changed.

(1-3) The information processing apparatus 100 determines the destination for which the visit plan is to be changed, among the destinations unvisited by any mobile body 101 of the plurality of mobile bodies 101 included in the plurality of destinations on the basis of the acquired remaining time. The information processing apparatus 100 determines, for example, the destination for which the visit plan is to be changed such that the change processing of changing the visit plan by the entire plurality of mobile bodies 101 is completed in the acquired remaining time.

In the example of FIG. 1, the information processing apparatus 100 determines the destination for which the visit plan by each vehicle i is to be changed such that the change processing of changing the visit plan by one or more vehicles i as a whole is completed in the acquired remaining time. More specifically, the information processing apparatus 100 determines the destination C and the destination D as the destinations for which the visit plan is to be changed regarding the vehicle 1. As a result, the information processing apparatus 100 can narrow down the destinations for which the visit plan is to be changed and can appropriately change the moving route of each mobile body 101.

(1-4) The information processing apparatus 100 changes the moving route of each mobile body 101 on the basis of the determined destination. The information processing apparatus 100 changes the moving route of each mobile body 101 so as to change the visit plan of the determined destination, for example. Specifically, the moving route of the vehicle 1 is changed to, for example, “the destination A->the destination B->the destination D->the destination C->the destination E-> . . . ” indicated by reference numeral 120.

As a result, in changing the moving route of each mobile body 101, the information processing apparatus 100 keeps a partial route to any one of unvisited destinations by the mobile body 101 unchanged, of the moving route of the mobile body 101. Therefore, the information processing apparatus 100 can prevent the changed moving route from not matching the moving status of the mobile body 101 and becoming an ineffective moving route.

Here, conventionally, if the moving route of the vehicle 1 is tried to be changed while the vehicle 1 is moving to the destination B, the moving route of the vehicle 1 is changed without considering the moving status of the vehicle 1. Specifically, conventionally, the moving route of the vehicle 1 is changed to “the destination A->the destination C->the destination B->the destination D->the destination E-> . . . ” indicated by reference numeral 130. However, the vehicle 1 continues to move even while the moving route is being changed, and at the time when the moving route has been changed, the vehicle 1 may have already arrived at the destination B or departed from the destination B. Therefore, the vehicle 1 may not be able to move along the changed moving route. Therefore, the changed moving route may not be an effective moving route.

In contrast, the information processing apparatus 100 considers the moving status of the vehicle 1 and can change the moving route, narrowing down the moving route to the partial route on and after the destination B, of the moving route of the vehicle 1, by the time when the vehicle 1 arrives at and departs the destination B. Specifically, the moving route of the vehicle 1 is changed to “the destination A->the destination B->the destination D->the destination C->the destination E-> . . . ” indicated by reference numeral 120. In this way, the information processing apparatus 100 can change the moving route such that the vehicle 1 can move along the changed moving route. Furthermore, the information processing apparatus 100 can change the moving route such that the changed moving route becomes an effective moving route.

Here, the case in which the information processing apparatus 100 acquires the remaining time to when each mobile body 101 departs one destination after a visit, of unvisited destinations by the mobile body 101, the unvisited destinations existing on the moving route of the mobile body 101, has been described but the embodiment is not limited to the case. For example, there may be case where the information processing apparatus 100 acquires a remaining time to when each mobile body 101 visits one destination, of unvisited destinations by the mobile body 101, the unvisited destinations existing on the moving route of the mobile body 101.

Here, the case in which the information processing apparatus 100 acquires the remaining time to when each mobile body 101 departs, after a visit, one destination planned to be visited next by the mobile body 101, the destination existing on the moving route of the mobile body 101, has been described but the embodiment is not limited to the case. For example, there may be case where the information processing apparatus 100 acquires a remaining time to when each mobile body 101 departs, after a visit, a destination planned to be visited existing n points ahead of the current location of the mobile body 101 on the moving route of the mobile body 101.

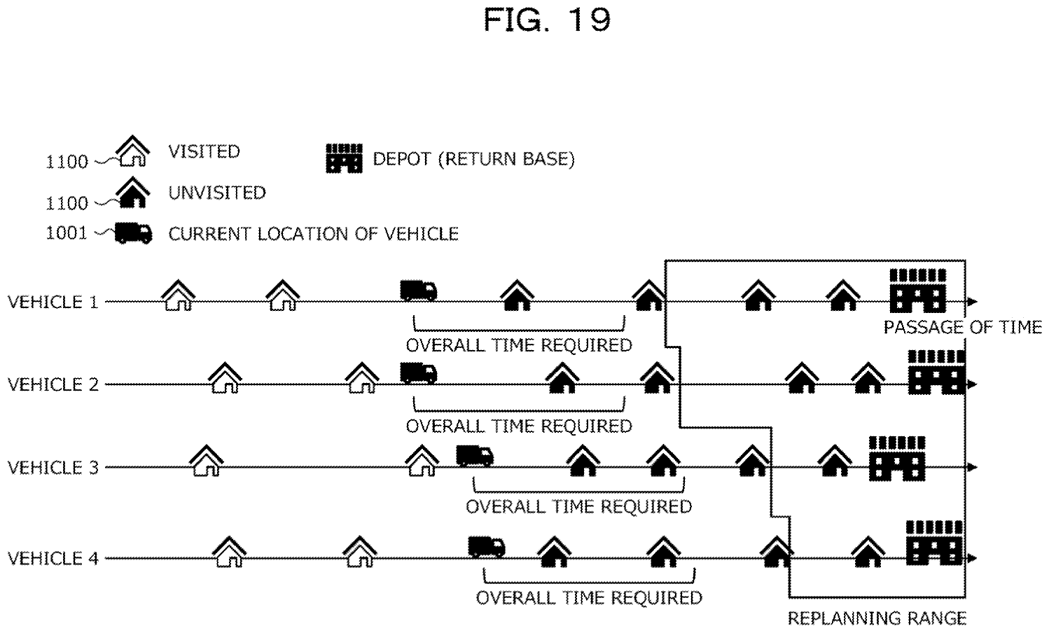

Here, the case in which the information processing apparatus 100 uses the remaining time to when each mobile body 101 departs, after a visit, one destination of unvisited destinations, as information serving as a guideline for narrowing down the destinations for which the visit plan is to be changed, has been described, but the embodiment is not limited to the case. For example, there may be a case in which the information processing apparatus 100 uses the time required for changing the moving route of each mobile body 101 as the information serving as a guideline for narrowing down the destinations for which the visit plan is to be changed. Specific examples corresponding to this case will be described below with reference to, for example, FIGS. 19 to 22.

(One Example of Information Processing System 200)

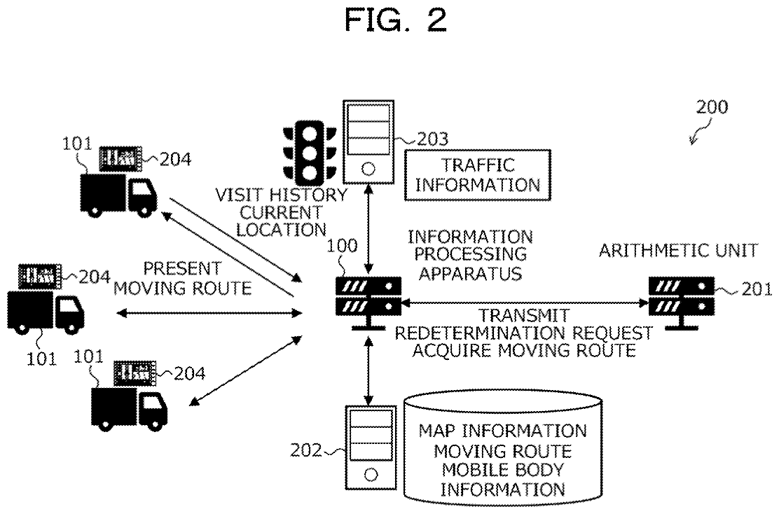

Next, one example of the information processing system 200 to which the information processing apparatus 100 illustrated in FIG. 1 is applied will be described with reference to FIG. 2.

FIG. 2 is an explanatory diagram illustrating one example of the information processing system 200. In FIG. 2, the information processing system 200 includes an information processing apparatus 100, an arithmetic unit 201, an accumulation apparatus 202, a traffic management apparatus 203, and an on-board apparatus 204 mounted on each mobile body 101.

In the information processing system 200, the information processing apparatus 100 and the arithmetic unit 201 are connected via a wired or wireless network. The network is, for example, a local area network (LAN), a wide area network (WAN), the Internet, or the like. Furthermore, the information processing apparatus 100 and the accumulation apparatus 202 are connected via a wired or wireless network. Furthermore, the information processing apparatus 100 and the traffic management apparatus 203 are connected via a wired or wireless network. The information processing apparatus 100 and the on-board apparatus 204 are connected via a wired or wireless network.

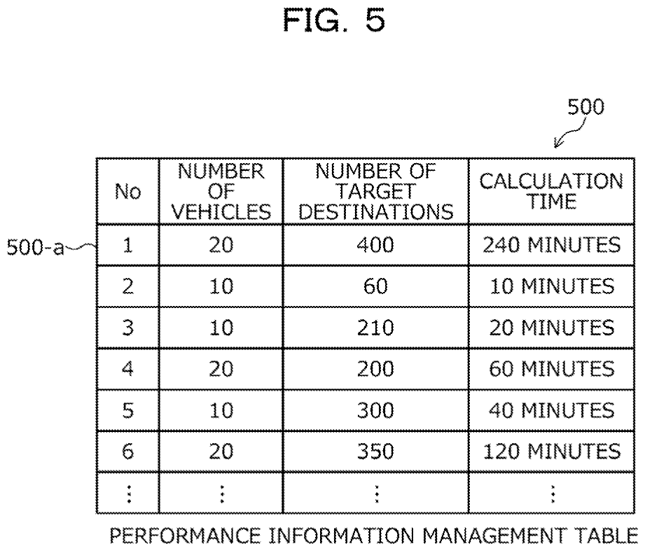

The information processing apparatus 100 is a computer for determining or changing the moving route of each mobile body 101. The information processing apparatus 100 stores, for example, a performance information management table 500, which will be described below with reference to FIG. 5. The performance information management table 500 stores, for example, the time required when determining the moving route in the past. Specifically, the performance information management table 500 stores conditions used when determining the moving route in the past and the time required when determining the moving route in the past in association with each other. The conditions are, for example, the number of mobile bodies 101 and the number of destinations.

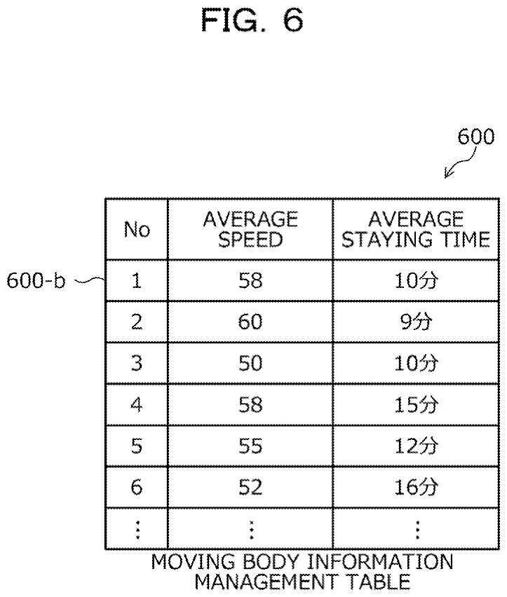

The information processing apparatus 100 receives, for example, map information from the accumulation apparatus 202. The information processing apparatus 100 receives, for example, mobile body information from the accumulation apparatus 202. The mobile body information includes, for example, an average speed of the mobile body 101 and an average staying time of the mobile body 101. The mobile body information is stored in, for example, a mobile body information management table 600, which will be described below with reference to FIG. 6. The information processing apparatus 100 periodically receives traffic information from the traffic management apparatus 203, for example. The traffic information indicates, for example, a road condition. The road condition is, for example, occurrence of a traffic jam, occurrence of a traffic accident, start of road construction, start of street closure, or the like.

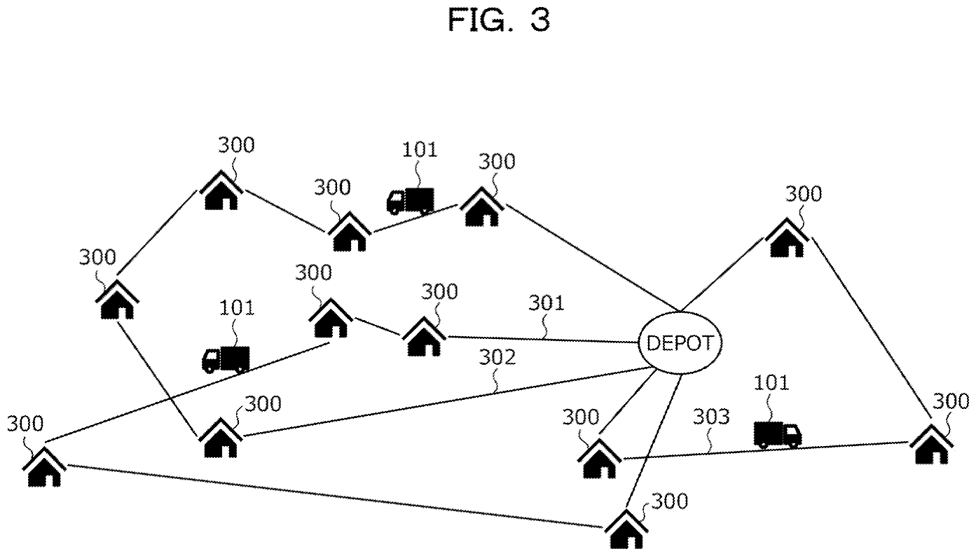

The information processing apparatus 100 transmits, for example, a determination request for determining the initial moving route of each mobile body 101 including the received map information, the received mobile body information, and the received traffic information, to the arithmetic unit 201. The information processing apparatus 100 receives, for example, the initial moving route of each mobile body 101 from the arithmetic unit 201. The information processing apparatus 100 transmits, for example, the initial moving route of each mobile body 101 to the on-board apparatus 204 mounted on the mobile body 101. Furthermore, the information processing apparatus 100 transmits, for example, the initial moving route of each mobile body 101 to the accumulation apparatus 202. An example of the moving route will be described below with reference to, for example, FIG. 3.

The information processing apparatus 100 receives, for example, progress information of each mobile body 101 from the on-board apparatus 204 mounted on the mobile body 101. The progress information includes, for example, a current location of the mobile body 101 and a visit history. The visit history enables specification of a visited destination that the mobile body 101 has already visited and an unvisited destination that the mobile body 101 has not visited yet. The information processing apparatus 100 determines whether to change the moving route of each mobile body 101 on the basis of, for example, the progress information of each mobile body 101, the traffic information, and the like.

Furthermore, in a case of receiving the change request for requesting to change the moving route of each mobile body 101 on the basis of an operation input of a user, for example, the information processing apparatus 100 may determine to change the moving route of each mobile body 101. Furthermore, in a case of receiving the change request for requesting to change the moving route of one mobile body 101 from the on-board apparatus 204 mounted on the mobile body 101, the information processing apparatus 100 may determine to change the moving route of each mobile body 101.

When determining to change the moving route of each mobile body 101, for example, the information processing apparatus 100 narrows down the destinations for which the visit plan is to be changed among a plurality of destinations. Specifically, the information processing apparatus 100 calculates the remaining time to when each mobile body 101 departs, after a visit, the destination planned to be visited next on the basis of the mobile body information of each mobile body 101 and the progress information of each mobile body 101. Then, specifically, the information processing apparatus 100 refers to the performance information management table 500, and specifies the number of destinations for which the visit plan is changeable within a minimum value range of the remaining time on the basis of the minimum value of the calculated remaining time. Thereafter, the information processing apparatus 100 narrows down the destinations for which the visit plan is to be changed within the range of the specified number.

The information processing apparatus 100 transmits, for example, a redetermination request for redetermining the moving route of each mobile body 101 including the received map information, the received mobile body information, the received traffic information, and the narrowed destinations, to the arithmetic unit 201. The information processing apparatus 100 receives, for example, the moving route of each mobile body 101 from the arithmetic unit 201. The information processing apparatus 100 transmits, for example, the moving route of each mobile body 101 to the on-board apparatus 204 mounted on the mobile body 101. Furthermore, the information processing apparatus 100 transmits, for example, the moving route of each mobile body 101 to the accumulation apparatus 202. For example, the information processing apparatus 100 is a server, a personal computer (PC), or the like.

The arithmetic unit 201 is a computer that determines the moving route of each mobile body 101 under the control of the information processing apparatus 100. The arithmetic unit 201 has a function to solve a combinatorial optimization problem by a mathematical optimization method. The arithmetic unit 201 transmits the determined moving route of each mobile body 101 to the information processing apparatus 100. The arithmetic unit 201 is, for example, a server or a PC, or the like.

The accumulation apparatus 202 is a computer that manages the map information, moving routes, mobile body information, and the like. The accumulation apparatus 202 provides the information processing apparatus 100 with the map information, moving routes, mobile body information, and the like. The accumulation apparatus 202 is, for example, a server, a PC, or the like. The traffic management apparatus 203 is a computer that manages the traffic information. The traffic management apparatus 203 provides the information processing apparatus 100 with the traffic information. The traffic management apparatus 203 is, for example, a server, a PC, or the like.

The on-board apparatus 204 is a computer mounted on the mobile body 101. The on-board apparatus 204 receives the moving route of the mobile body 101 on which the on-board apparatus itself is mounted from the information processing apparatus 100. The on-board apparatus 204 outputs the moving path of the mobile body 101 on which the on-board apparatus itself is mounted in such a manner that a driver of the mobile body 101 can get the moving route. The on-board apparatus 204 periodically generates the progress information and transmits the progress information to the information processing apparatus 100. The on-board apparatus 204 is, for example, a PC, a tablet terminal, a smartphone, a car navigation apparatus, or the like.

Herein, the case in which the information processing apparatus 100 and the arithmetic unit 201 are different apparatuses has been described. However, the present embodiment is not limited to the case. For example, there may be a case in which the information processing apparatus 100 has a function as the arithmetic unit 201. In this case, the information processing system 200 may not include the arithmetic unit 201.

Herein, the case in which the information processing apparatus 100 and the accumulation apparatus 202 are different apparatuses has been described. However, the present embodiment is not limited to the case. For example, there may be a case in which the information processing apparatus 100 has a function as the accumulation apparatus 202. In this case, the information processing system 200 may not include the accumulation apparatus 202.

Here, the case in which the information processing apparatus 100 and the traffic management apparatus 203 are different apparatuses has been described, but the present embodiment is not limited to this case. For example, there may be a case in which the information processing apparatus 100 has a function as the traffic management apparatus 203. In this case, the information processing system 200 may not include the traffic management apparatus 203.

(One Example of Moving Routes)

Next, one example of the moving routes will be described with reference to FIG. 3.

FIG. 3 is an explanatory diagram illustrating one example of moving routes. In FIG. 3, the information processing apparatus 100 determines moving routes 301 to 303 of the mobile bodies 101. The information processing apparatus 100 determines the moving routes 301 to 303 of the mobile bodies 101 such that a cumulative travel time or a cumulative travel distance becomes short according to a predetermined algorithm. As illustrated in FIG. 3, the moving routes 301 to 303 are formed so as to pass through two or more destinations 300. A first starting point of the moving routes 301 to 303 is a depot. The depot is, for example, a delivery base. A final arrival point of the moving routes 301 to 303 is the depot. Therefore, the moving routes 301 to 303 are, for example, closed paths.

(Hardware Configuration Example of Information Processing Apparatus 100)

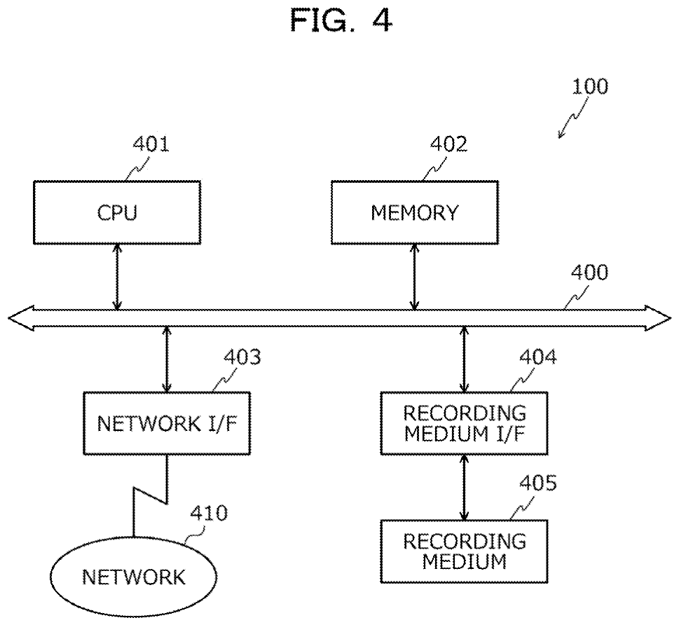

Next, a hardware configuration example of the information processing apparatus 100 will be described with reference to FIG. 4.

FIG. 4 is a block diagram illustrating a hardware configuration example of the information processing apparatus 100. In FIG. 4, the information processing apparatus 100 includes a central processing unit (CPU) 401, a memory 402, a network interface (I/F) 403, a recording medium I/F 404, and a recording medium 405. Furthermore, the respective configuration units are connected to each other by a bus 400.

Here, the CPU 401 is in charge of overall control of the information processing apparatus 100. The memory 402 has, for example, a read only memory (ROM), a random access memory (RAM), a flash ROM, and the like. Specifically, for example, the flash ROM or the ROM stores various types of programs, while the RAM is used as a work area for the CPU 401. The programs stored in the memory 402 are loaded into the CPU 401 to cause the CPU 401 to execute coded processing.

The network I/F 403 is connected to the network 410 through a communication line, and is connected to another computer through the network 410. Then, the network I/F 403 manages an interface between the network 410 and an inside, and controls input and output of data to and from another computer. For example, the network I/F 403 is a modem, a LAN adapter, or the like.

The recording medium I/F 404 controls reading and writing of data from and to the recording medium 405 under the control of the CPU 401. For example, the recording medium I/F 404 is a disk drive, a solid state drive (SSD), a universal serial bus (USB) port, or the like. The recording medium 405 is a nonvolatile memory that stores data written under the control of the recording medium I/F 404. For example, the recording medium 405 is a disk, a semiconductor memory, a USB memory, or the like. The recording medium 405 may be attachable to and detachable from the information processing apparatus 100.

For example, the information processing apparatus 100 may include a keyboard, a mouse, a display, a printer, a scanner, a microphone, a speaker, or the like in addition to the configuration units described above. Furthermore, the information processing apparatus 100 may include a plurality of the recording medium I/Fs 404 and the recording medium 405. In addition, the information processing apparatus 100 does not have to include the recording medium I/F 404 or the recording medium 405.

(Stored Content in Performance Information Management Table 500)

Next, one example of stored content in the performance information management table 500 will be described with reference to FIG. 5. The performance information management table 500 is implemented by a storage area such as the memory 402 or the recording medium 405 of the information processing apparatus 100 illustrated in FIG. 4, for example.

FIG. 5 is an explanatory diagram illustrating one example of stored content in the performance information management table 500. As illustrated in FIG. 5, the performance information management table 500 has fields of No, the number of vehicles, the number of target destinations, and calculation time. In the performance information management table 500, performance information is stored as a record 500-a by setting information in each field every time a moving route is determined. a represents an arbitrary integer.

In the field of No, a number of the record is set. In the field of the number of vehicles, the number of vehicles indicating how many moving routes of mobile bodies have been determined when the moving route of each mobile body of one or more mobile bodies has been determined in the past is set. In other words, the number of vehicles is one of the conditions used in the past to determine the moving route of each mobile body of one or more mobile bodies.

In the field of the number of target destinations, the number of target destinations indicating how many destinations as a whole the moving route of each mobile body has been determined when the moving route of each mobile body of one or more mobile bodies has been determined in the past is set. In other words, the number of target destinations is one of the conditions used in the past to determine the moving route of each mobile body of one or more mobile bodies. In the field of calculation time, the calculation time when the moving route is determined in the past is set.

(Stored Content in Mobile Body Information Management Table 600)

Next, one example of stored content in the mobile body information management table 600 will be described with reference to FIG. 6. The mobile body information management table 600 is implemented by the storage area such as the memory 402 or the recording medium 405 of the information processing apparatus 100 illustrated in FIG. 4, for example.

FIG. 6 is an explanatory diagram illustrating one example of stored content in the mobile body information management table 600. As illustrated in FIG. 6, the mobile body information management table 600 has fields of No, average speed, and average staying time. In the mobile body information management table 600, mobile body information is stored as a record 600-b by setting information in each field for each mobile body. The letter b represents an arbitrary integer.

In the field of No, a number of the mobile body is set. In the field of average speed, an average speed of the mobile body is set. The unit of average speed is, for example, miles per hour. In the field of average staying time, an average staying time of the mobile body at visited destinations is set. The unit of average staying time is, for example, minutes. The average staying time is calculated on the basis of, for example, the time from when the mobile body stops to when the mobile body resumes moving at each destination of the plurality of destinations in the past. The average staying time is calculated on the basis of, for example, the time from when the power of the mobile body is stopped to when the mobile body is restarted at each destination of the plurality of destinations in the past. The power is, for example, an engine. The average staying time is calculated on the basis of, for example, the time from when the on-board apparatus 204 mounted on the mobile body is stopped to when the on-board apparatus is reactivated at each destination of the plurality of destinations in the past.

(Hardware Configuration Example of Arithmetic Unit 201)

Specifically, since the hardware configuration example of the arithmetic unit 201 is similar to the hardware configuration example of the information processing apparatus 100 illustrated in FIG. 4, description thereof will be omitted.

(Hardware Configuration Example of Accumulation Apparatus 202)

Specifically, since the hardware configuration example of the accumulation apparatus 202 is similar to the hardware configuration example of the information processing apparatus 100 illustrated in FIG. 4, description thereof will be omitted.

(Hardware Configuration Example of Traffic Management Apparatus 203)

Specifically, since the hardware configuration example of the traffic management apparatus 203 is similar to the hardware configuration example of the information processing apparatus 100 illustrated in FIG. 4, the description thereof will be omitted.

(Hardware Configuration Example of On-Board Apparatus 204)

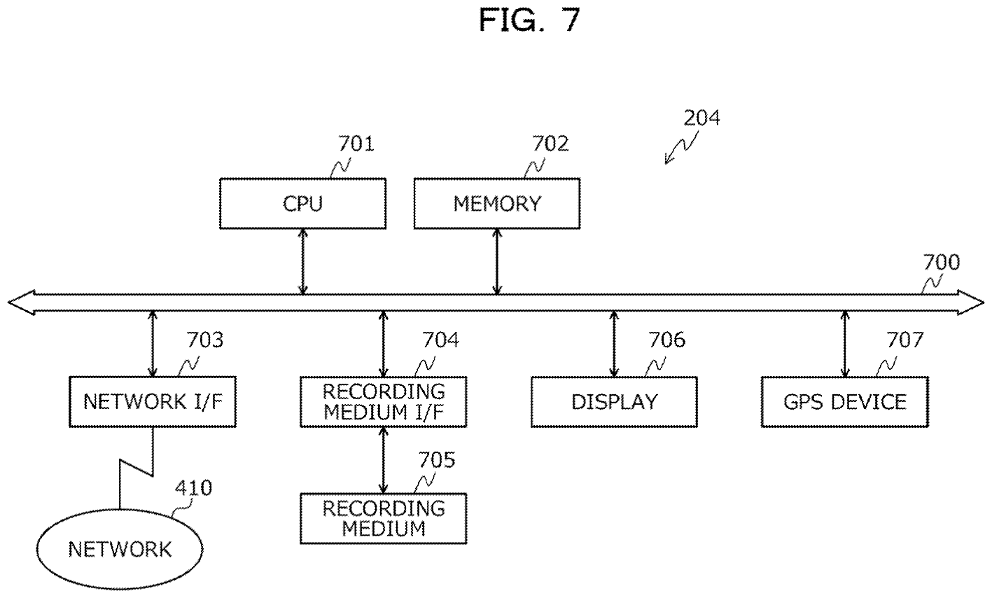

Next, a hardware configuration example of the on-board apparatus 204 included in the information processing system 200 illustrated in FIG. 2 will be described with reference to FIG. 7.

FIG. 7 is a block diagram illustrating a hardware configuration example of the on-board apparatus 204. In FIG. 7, the on-board apparatus 204 includes a CPU 701, a memory 702, a network I/F 703, a recording medium I/F 704, a recording medium 705, a display 706, and a global positioning system (GPS) device 707. Furthermore, the respective configuration units are connected to each other by a bus 700.

Here, the CPU 701 performs overall control of the on-board apparatus 204. The memory 702 includes, for example, a ROM, a RAM, a flash ROM, and the like. Specifically, for example, the flash ROM or the ROM stores various types of programs, while the RAM is used as a work area for the CPU 701. The programs stored in the memory 702 are loaded into the CPU 701 to cause the CPU 701 to execute coded processing.

The network I/F 703 is connected to the network 410 through a communication line, and is connected to another computer through the network 410. Then, the network I/F 703 manages an interface between the network 410 and an inside, and controls input and output of data to and from another computer. For example, the network I/F 703 is a modem, a LAN adapter, or the like.

The recording medium I/F 704 controls reading and writing of data from and to the recording medium 705 under the control of the CPU 701. The recording medium I/F 704 is, for example, a disk drive, an SSD, a USB port, or the like. The recording medium 705 is a nonvolatile memory that stores data written under the control of the recording medium I/F 704. For example, the recording medium 705 is a disk, a semiconductor memory, a USB memory, or the like. The recording medium 705 may be attachable to and detachable from the on-board apparatus 204.

The display 706 displays data such as a document, an image, and function information, as well as a cursor, an icon, or a tool box. The display 706 is, for example, a cathode ray tube (CRT), a liquid crystal display, an organic electroluminescence (EL) display, or the like. The GPS device 707 detects radio waves of GPS satellites. The GPS device 707 detects coordinates of the on-board apparatus 204 on the basis of the radio waves of the GPS satellites.

The on-board apparatus 204 may have, for example, a keyboard, a mouse, a display, a printer, a scanner, a microphone, a speaker, and the like in addition to the above-described configuration units. Further, the on-board apparatus 204 may have a plurality of the recording medium I/Fs 704 and a plurality of the recording media 705. Furthermore, the on-board apparatus 204 does not have to include the recording medium I/F 704 and the recording medium 705.

(Functional Configuration Example of Information Processing Apparatus 100)

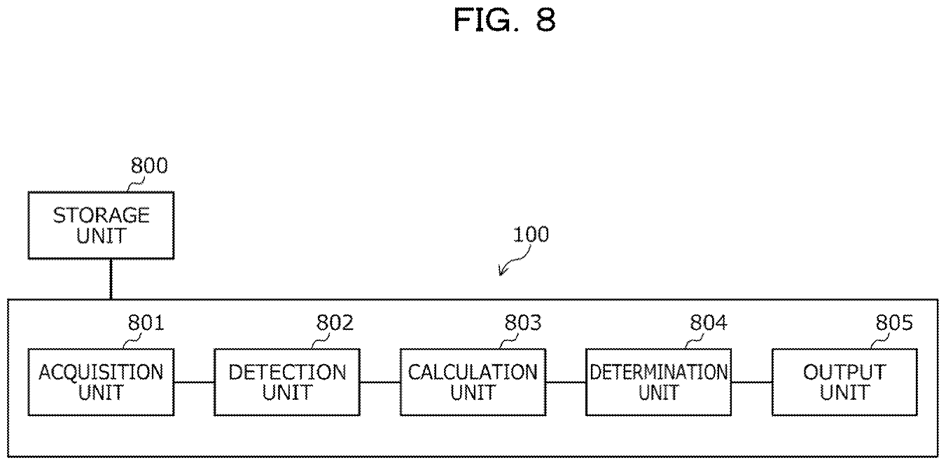

Next, a functional configuration example of the information processing apparatus 100 will be described with reference to FIG. 8.

FIG. 8 is a block diagram illustrating a functional configuration example of the information processing apparatus 100. The information processing apparatus 100 includes a storage unit 800, an acquisition unit 801, a detection unit 802, a calculation unit 803, a determination unit 804, and an output unit 805.

The storage unit 800 is implemented by, for example, the storage area such as the memory 402 or the recording medium 405 illustrated in FIG. 4. Hereinafter, a case where the storage unit 800 is included in the information processing apparatus 100 will be described. However, the storage unit 800 is not limited to this case. For example, there may be a case where the storage unit 800 is included in an apparatus different from the information processing apparatus 100, and the information processing apparatus 100 is allowed to refer to the stored contents of the storage unit 800.

The acquisition unit 801 to the output unit 805 function as an example of a control unit. Specifically, for example, the acquisition unit 801 to the output unit 805 implement functions thereof by causing the CPU 401 to execute a program stored in the storage area such as the memory 402 or the recording medium 405 illustrated in FIG. 4 or by the network I/F 403. A processing result of each functional unit is stored in the storage area such as the memory 402 or the recording medium 405 illustrated in FIG. 4, for example.

The storage unit 800 stores various types of information referred to or updated in the processing of each functional unit. The storage unit 800 stores the traffic information. The traffic information indicates, for example, a road condition. The road condition is, for example, occurrence of a traffic jam, occurrence of a traffic accident, start of road construction, start of street closure, or the like. The traffic information is acquired by, for example, the acquisition unit 801.

The storage unit 800 stores, for example, destination information including positions of respective destinations of the plurality of destinations. The destination is, for example, a delivery destination or a collection destination. The position of the destination is, for example, the coordinates of the destination. The destination is set by the user, for example. The destination information may further include a restriction on a visit time frame to the destination. The destination information is acquired by, for example, the acquisition unit 801.

The storage unit 800 stores, for example, the mobile body information including the average speed, the average staying time, and the like of each mobile body of the plurality of mobile bodies. Specifically, the storage unit 800 stores the mobile body information of each mobile body by using the mobile body information management table 600. The mobile body information is acquired by, for example, the acquisition unit 801.

The storage unit 800 stores the moving route of each mobile body. The moving route is, for example, a moving plan of the mobile body. The moving route is formed such that the mobile body passes through two or more destinations planned to be visited, for example. The storage unit 800 stores the moving route of each mobile body currently being adopted. The moving route is generated by, for example, the determination unit 804.

The storage unit 800 stores the progress information including, for example, the position and the visit history of each mobile body of the plurality of mobile bodies. The position of the mobile body is, for example, the coordinates of the mobile body. The visit history enables specification of a visited destination that the mobile body has already visited and an unvisited destination that the mobile body has not visited yet. The progress information is acquired by, for example, the acquisition unit 801.

The storage unit 800 stores a model for enabling calculation of a processing time required for the change processing. The change processing is processing of changing the visit plan for at least one of the destinations in order to change the moving route of each mobile body. The model is, for example, a mathematical expression. The model may be, for example, a neural network. The model is, for example, a mathematical expression for calculating the processing time required for the change processing of changing the visit plan for each destination according to the number of mobile bodies and the number of destinations for which the visit plan is to be changed. The model is generated by, for example, the calculation unit 803 on the basis of the performance information management table 500. The model is acquired by, for example, the acquisition unit 801.

The storage unit 800 stores time information that serves as a guideline for narrowing down the destinations for which the visit plan is to be changed. The time information is, for example, the remaining time to when each mobile body visits one destination, of unvisited destinations by the mobile body, the unvisited destinations existing on the moving route of the mobile body, or the remaining time to when the mobile body departs, after a visit, the destination. The time information is, for example, the time required for changing the moving route of each mobile body. The time information is calculated by, for example, the calculation unit 803. The time information is acquired by, for example, the acquisition unit 801.

The acquisition unit 801 acquires various types of information to be used for the processing of each functional unit. The acquisition unit 801 stores the acquired various types of information in the storage unit 800 or outputs the acquired various types of information to each functional unit. Furthermore, the acquisition unit 801 may output the various sorts of information stored in the storage unit 800 to each functional unit. The acquisition unit 801 acquires the various types of information on the basis of, for example, the user's operation input. The acquisition unit 801 may receive the various sorts of information from an apparatus different from the information processing apparatus 100, for example.

The acquisition unit 801 acquires, for example, the traffic information. The acquisition unit 801 acquires, specifically, the traffic information by receiving the traffic information from the another computer. Another computer is, for example, the traffic management apparatus 203. The traffic information is used when, for example, the detection unit 802 detects the change the moving route of each mobile body. The traffic information is used when, for example, the calculation unit 803 generates the time information. The traffic information is used when, for example, the determination unit 804 determines the moving route of each mobile body.

The acquisition unit 801 acquires, for example, the destination information. The acquisition unit 801 acquires the destination information by accepting an input of the destination information on the basis of the user's operation input, for example. The destination information is used when, for example, the detection unit 802 detects the change the moving route of each mobile body. The destination information is used when, for example, the calculation unit 803 generates the time information. The destination information is used when, for example, the determination unit 804 determines the moving route of each mobile body.

The acquisition unit 801 acquires, for example, the mobile body information. Specifically, the acquisition unit 801 acquires the mobile body information by accepting an input of the mobile body information on the basis of the user's operation input. The mobile body information is used when, for example, the detection unit 802 detects the change the moving route of each mobile body. The mobile body information is used when, for example, the calculation unit 803 generates the time information. The mobile body information is used when, for example, the determination unit 804 determines the moving route of each mobile body.

The acquisition unit 801 acquires, for example, the progress information of each mobile body. Specifically, the acquisition unit 801 acquires the progress information of each mobile body by receiving the progress information of each mobile body from another computer. Another computer is, for example, the on-board apparatus 204 mounted on the mobile body. The progress information is used when, for example, the detection unit 802 detects to change the moving route of each mobile body. The progress information is used when, for example, the calculation unit 803 generates the time information. The progress information is used when, for example, the determination unit 804 determines the moving route of each mobile body.

The acquisition unit 801 acquires, for example, the model for enabling calculation of the processing time required for the change processing. Specifically, for example, the acquisition unit 801 acquires the model by receiving the model from another computer. Specifically, the acquisition unit 801 acquires the model by accepting an input of the model on the basis of the user's operation input. The model is used when, for example, the calculation unit 803 generates the time information. The model is used when, for example, the determination unit 804 determines the moving route of each mobile body.

The acquisition unit 801 acquires, for example, the time information. The acquisition unit 801 acquires, specifically, the time information by receiving the time information from another computer. Another computer is, for example, the on-board apparatus 204 mounted on the mobile body. Specifically, the acquisition unit 801 receives the time information from another computer when the calculation unit 803 does not generate the time information. The time information is used when, for example, the determination unit 804 determines the moving route of each mobile body.

The acquisition unit 801 acquires, for example, the change request for requesting to change the moving route of the mobile body. Specifically, the acquisition unit 801 acquires the change request by accepting an input of the change request on the basis of the user's operation input. The acquisition unit 801 acquires, specifically, the change request by receiving the change request from another computer. Another computer is, for example, the on-board apparatus 204 mounted on one mobile body.

The acquisition unit 801 acquires, for example, an update request for requesting addition or deletion of a destination or change of the restriction on the visit time frame. For example, the deletion of a destination occurs when the visit plan for the destination is canceled or when the visit plan for the destination is postponed for tomorrow or after tomorrow, for example. The acquisition unit 801 acquires, specifically, the update request by receiving the update request from another computer. Specifically, the acquisition unit 801 may update the destination information stored in the storage unit 800 in response to the update request.

The acquisition unit 801 may accept a start trigger to start the processing of any one of the functional units. The start trigger is, for example, a predetermined operation input made by the user. The start trigger may be, for example, reception of predetermined information from another computer. The start trigger may be, for example, output of predetermined information by one of the functional units.

The detection unit 802 detects the need to collectively change the moving routes of the respective mobile bodies of the plurality of mobile bodies. The detection unit 802 detects the need to collectively change the moving routes of the respective mobile bodies on the basis of at least one of the traffic information, the destination information, the mobile body information, and the progress information acquired by the acquisition unit 801, for example.

Specifically, the detection unit 802 determines whether a traffic jam, a traffic accident, a street closure, or the like has occurred on the moving route of each mobile body on the basis of the traffic information. Then, specifically, when it is determined that a traffic jam, a traffic accident, a street closure, or the like has occurred, the detection unit 802 detects the need to collectively change the moving routes of the respective mobile bodies. Thereby, the detection unit 802 enables the moving routes of the respective mobile bodies to be collectively changed at appropriate timing.

Specifically, the detection unit 802 determines whether a prediction value at the time when any mobile body visits any destination satisfies the restriction on the visit time frame on the basis of the traffic information, the destination information, the mobile body information, and the progress information. Then, when the detection unit 802 detects the need to collectively change the moving routes of the respective mobile bodies in a case of determining that the prediction value does not satisfy the restriction on the visit time frame. Thereby, the detection unit 802 enables the moving routes of the respective mobile bodies to be collectively changed at appropriate timing.

For example, the detection unit 802 may detect the need to collectively change the moving routes of the respective mobile bodies in response to acquisition of the change request or the update request of the acquisition unit 801. Thereby, the detection unit 802 can detect the need to collectively change the moving routes of the respective mobile bodies, and enables the moving routes of the respective mobile bodies to be collectively changed at an appropriate time.

The calculation unit 803 generates the time information. When detecting to change the moving route of each mobile body, the calculation unit 803 calculates the remaining time to when the mobile body visits one destination of unvisited destinations by the mobile body, the unvisited destinations existing on the moving route of each mobile body, for example. Specifically, the calculation unit 803 calculates the remaining time to when each mobile body visits the destination planned to be visited by the mobile body n points later on the basis of the traffic information, the destination information, the mobile body information, and the progress information, for example. n is an integer of 1 or larger. More specifically, the calculation unit 803 calculates the remaining time to when each mobile body visits the destination planned to be visited next by the mobile body. Thereby, the calculation unit 803 can obtain the information that serves as a guideline for narrowing down the destinations for which the visit plan is to be changed when the determination unit 804 determines the moving route of each mobile body.

When detecting to change the moving route of each mobile body, the calculation unit 803 calculates the remaining time to when the mobile body departs, after a visit, one destination of unvisited destinations by the mobile body, the unvisited destinations existing on the moving route of each mobile body, for example. Specifically, the calculation unit 803 calculates the remaining time to when each mobile body departs, after a visit, the destination planned to be visited by the mobile body n points later on the basis of the traffic information, the destination information, the mobile body information, and the progress information, for example. More specifically, the calculation unit 803 calculates the remaining time to when each mobile body departs, after a visit, the destination planned to be visited next by the mobile body. Thereby, the calculation unit 803 can obtain the information that serves as a guideline for narrowing down the destinations for which the visit plan is to be changed when the determination unit 804 determines the moving route of each mobile body.

When detecting to change the moving route of each mobile body, the calculation unit 803 acquires the time required for changing the moving route of each mobile body on the basis of a destination unvisited by any mobile body of the plurality of destinations. The calculation unit 803 acquires the time required for changing the moving route of each mobile body on the basis of a destination unvisited by any mobile body by reference to the progress information using the model, for example. Specifically, the calculation unit 803 acquires the time required for changing the moving route of each mobile body, which is output from the model, by inputting the number of destinations unvisited by any mobile body to the model. Thereby, the calculation unit 803 can obtain the information that serves as a guideline for narrowing down the destinations for which the visit plan is to be changed when the determination unit 804 determines the moving route of each mobile body.

The calculation unit 803 generates the model or updates the model. After the movement of each mobile body is completed, the calculation unit 803 generates the model or updates the model on the basis of the destination information, the mobile body information, and the progress information. Thereby, the calculation unit 803 can improve the accuracy of the model and can accurately calculate the time required for changing the moving route of each mobile body.

The determination unit 804 determines the destination for which the visit plan is to be changed on the basis of the time information acquired by the acquisition unit 801 or calculated by the calculation unit 803. The determination unit 804 determines, for example, the destination for which the visit plan is to be changed, among the destinations unvisited by any mobile body of the plurality of mobile bodies included in the plurality of destinations on the basis of the acquired remaining time. The determination unit 804 determines, for example, the destination for which the visit plan is to be changed, among the destinations unvisited by any mobile body, on the basis of a statistical value of the remaining time. The statistical value is, for example, a maximum value, a minimum value, a mode, a median, or the like. The statistical value is favorably the minimum value, for example.

Specifically, the determination unit 804 specifies the number of destinations for which the visit plan is changeable with the minimum value of the remaining time, among the plurality of destinations, using the model. Then, the determination unit 804 specifically determines the destination for which the visit plan is to be changed on the basis of the specified number. More specifically, the determination unit 804 acquires the number of destinations output from the model by inputting the number of mobile bodies and the minimum value of the remaining time to the model, and sets the acquired number as the number of destinations for which the visit plan is changeable. Then, more specifically, the determination unit 804 selects the specified number of unvisited destinations included in an area corresponding to each mobile body, and determines the selected destinations as the destinations for which the visit plan is to be changed.

The area is, for example, an area with the destination planned to be visited by the mobile body as a reference point. The area may be, for example, an area with the starting point at which each mobile body first departs as a reference point. The area may be, for example, an area with the arrival point at which each mobile body finally arrives as a reference point. The area is set on the basis of a linear distance from the reference point. The area is set on the basis of the travel time from the reference point.

At this time, more specifically, the determination unit 804 expands the area corresponding to each mobile body until the total number of destinations unvisited by any mobile body included in the area exceeds the specified number. More specifically, the determination unit 804 selects the specified number of destinations unvisited by any mobile body included in the expanded area, and determines the selected destinations as the destinations for which the visit plan is to be changed. As a result, the determination unit 804 can narrow down the destinations for which the visit plan is to be changed and enables the moving routes of the respective mobile bodies to be collectively and appropriately changed.

The determination unit 804 determines, for example, the destinations for which the visit plan is to be changed, among the destinations unvisited by any mobile body of the plurality of mobile bodies included in the plurality of destinations on the basis of the time required. Specifically, the determination unit 804 determines the remaining destinations excluding the visitable destinations in the acquired time required and the destinations planned to be visited next after the acquired time required, among the destinations unvisited by any mobile body, as the destinations for which the visit plan is to be changed. As a result, the determination unit 804 can narrow down the destinations for which the visit plan is to be changed and enables the moving routes of the respective mobile bodies to be collectively and appropriately changed.

The determination unit 804 changes the moving route of each mobile body on the basis of the determined destinations. The determination unit 804 determines a new moving route of each mobile body and changes the moving route of each mobile body by changing the visit plan of the determined destinations without changing the visit plan of the destinations other than the determined determinations. Thereby, the determination unit 804 can appropriately change the moving route of each mobile body.

The determination unit 804 may cause the arithmetic unit 201 to determine the new moving route of each mobile body by transmitting the determined destinations to the arithmetic unit 201, and acquire the new moving route of each mobile body from the arithmetic unit 201. Thereby, the determination unit 804 can appropriately change the moving route of each mobile body. The determination unit 804 may determine the initial moving route of each mobile body. As a result, the determination unit 804 can allow each mobile body to start moving.

The output unit 805 outputs a processing result of at least any one of the functional units. An output format is, for example, display on a display, print output to a printer, transmission to an external apparatus by the network I/F 403, or storage in the storage area such as the memory 402 or the recording medium 405. Thereby, the output unit 805 enables the processing result of at least one of the functional units to be notified to the user and can improve the convenience of the information processing apparatus 100.

The output unit 805 outputs the moving route of each mobile body determined by the determination unit 804. The output unit 805 transmits, for example, the moving route of each mobile body to the on-board apparatus 204 mounted on the mobile body. As a result, the output unit 805 can appropriately move the mobile body along the determined moving route of each mobile body.

(Specific Functional Configuration Example of Information Processing Apparatus 100)

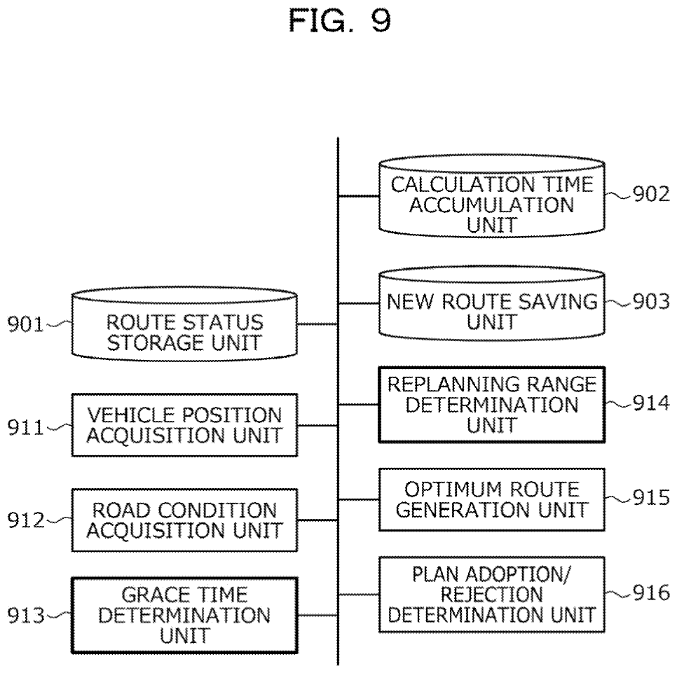

Next, a specific functional configuration example of the information processing apparatus 100 will be described with reference to FIG. 9.

FIG. 9 is a block diagram illustrating a specific functional configuration example of the information processing apparatus 100. The information processing apparatus 100 includes a route status storage unit 901, a calculation time accumulation unit 902, and a new route saving unit 903. Furthermore, the information processing apparatus 100 includes a vehicle position acquisition unit 911, a road condition acquisition unit 912, a grace time determination unit 913, a replanning range determination unit 914, an optimum route generation unit 915, and a plan adoption/rejection determination unit 916.

The route status storage unit 901 stores, for example, the coordinates of a delivery vehicle acquired by the GPS device of the delivery vehicle. The route status storage unit 901 stores, for example, flag information indicating whether the delivery vehicle has already visited each delivery destination planned to be visited. The route status storage unit 901 stores, for example, traffic information acquired from vehicle information and communication system (VICS). VICS is a registered trademark.

The calculation time accumulation unit 902 stores, for example, conditions and a time required when a delivery plan was drawn up in the past. The delivery plan includes the moving route of each delivery vehicle. The drawing up the plan is to determine the moving route of each delivery vehicle. The conditions are the number of delivery vehicles, the number of delivery destinations, and the like. The new route saving unit 903 stores, for example, the latest delivery plan. Specifically, the new route saving unit 903 stores the latest moving route of each delivery vehicle as the latest delivery plan.

The vehicle position acquisition unit 911 receives, for example, the coordinates of the delivery vehicle acquired from the GPS device of the delivery vehicle from the on-board apparatus 204 mounted on the delivery vehicle. The vehicle position acquisition unit 911 stores, for example, the received coordinates of the delivery vehicle in the route status storage unit 901. The vehicle position acquisition unit 911 receives, for example, the flag information indicating whether the delivery vehicle has already visited each delivery destination planned to be visited from the on-board apparatus 204 mounted on the delivery vehicle. The vehicle position acquisition unit 911 stores, for example, the received flag information in the route status storage unit 901. The road condition acquisition unit 912 acquires the traffic information from the VICS, for example. The road condition acquisition unit 912 stores the acquired traffic information in the route status storage unit 901.

The grace time determination unit 913 determines, for example, the grace time that can be used for drawing up a delivery plan. Specifically, the grace time determination unit 913 calculates the remaining time to when each delivery vehicle departs, after a visit, the delivery destination planned to be visited next, as the grace time that can be used for drawing up the delivery plan on the basis of the coordinates of the delivery vehicle, the flag information, and the traffic information. The grace time determination unit 913 may determine, for example, the time required for drawing up a new delivery plan for a delivery destination unvisited by any delivery vehicle. Specifically, the grace time determination unit 913 generates a model for determining the time required by reference to the calculation time accumulation unit 902, and determines the time required for drawing up a new delivery plan for a delivery destination unvisited by any delivery vehicle, using the generated model.

For example, the replanning range determination unit 914 determines the delivery destination to be processed when drawing up the new delivery plan and for which the visit plan is to be changed, among the delivery destinations unvisited by any delivery vehicle on the basis of the grace time. Specifically, the replanning range determination unit 914 specifies an upper limit of the number of delivery destinations to be processed for which processing of drawing up a delivery plan within the grace time. Then, the replanning range determination unit 914 determines the delivery destination to be processed when drawing up the new delivery plan and for which the visit plan is to be changed, among the delivery destinations unvisited by any delivery vehicle within the specified upper limit.

The optimum route generation unit 915 draws up, for example, an initial delivery plan. The drawing up the plan is to determine the moving route of each delivery vehicle. Specifically, the optimum route generation unit 915 draws up the initial delivery plan by using a mathematical optimization method. The optimum route generation unit 915 redraws up the delivery plan for the delivery destination for which the visit plan is to be changed, for example. Specifically, the optimum route generation unit 915 redraws up the delivery plan for the delivery destination for which the visit plan is to be changed, using the mathematical optimization method.

The plan adoption/rejection determination unit 916 determines, for example, whether to adopt the delivery plan drawn up by the optimum route generation unit 915. Specifically, the plan adoption/rejection determination unit 916 adopts the newly drawn-up delivery plan if the newly drawn-up delivery plan is more appropriate than the currently adopted delivery plan. Appropriate means, for example, that the delivery cost is relatively low. Furthermore, the plan adoption/rejection determination unit 916 adopts the newly drawn-up delivery plan if the delivery plan being adopted is inappropriate due to addition of delivery destinations or the like.

(First Operation Example of Information Processing Apparatus 100)

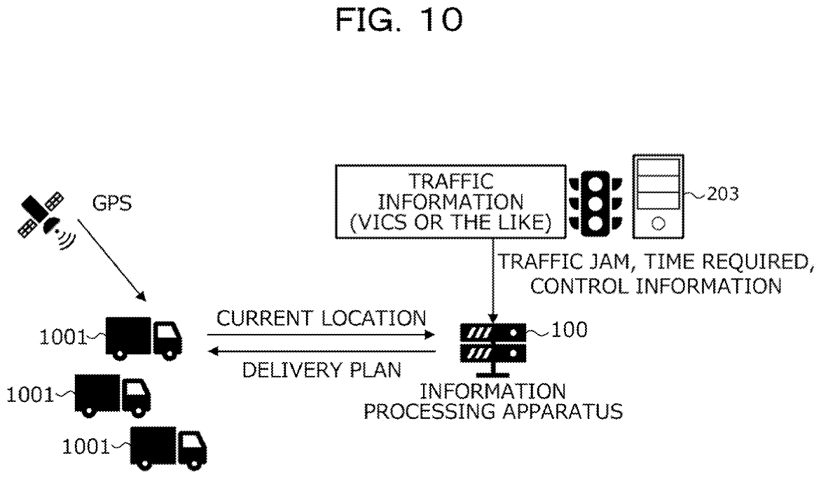

Next, a first operation example of the information processing apparatus 100 will be described with reference to FIGS. 10 to 16.

FIGS. 10 to 16 are explanatory diagrams illustrating a first operation example of the information processing apparatus 100. In FIG. 10, the information processing apparatus 100 draws up and adopts initial delivery plans by setting all of delivery destinations as destinations for which the visit plan is to be determined and determining an initial moving route of each delivery vehicle 1001. The information processing apparatus 100 draws up the initial delivery plan, for example, the day before the delivery operation.

The information processing apparatus 100 transmits the initial moving route of each delivery vehicle 1001 to the on-board apparatus 204 mounted on the delivery vehicle 1001. The delivery vehicle 1001 outputs the moving route such that the driver can grasp it. The driver drives the delivery vehicle 1001 and moves the delivery vehicle 1001 along the moving route to carry out the delivery operation.

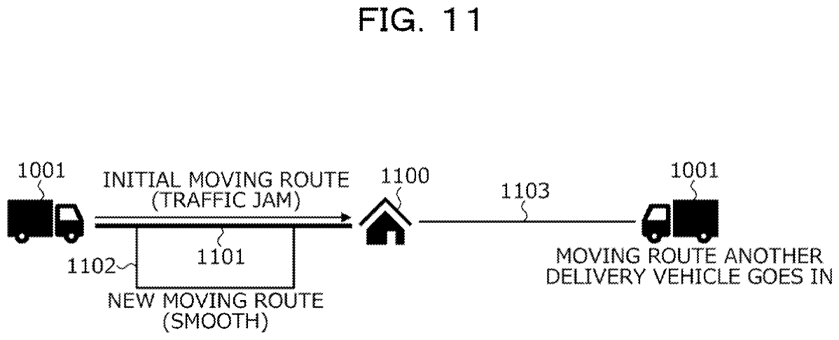

The delivery vehicle 1001 periodically transmits the progress information including the current location of the delivery vehicle 1001 and the visit history of the delivery vehicle 1001 to the information processing apparatus 100 during the movement. While each delivery vehicle 1001 is moving, the information processing apparatus 100 periodically receives the progress information including the current location of the delivery vehicle 1001 and the visit history of the delivery vehicle 1001 from each delivery vehicle 1001. Furthermore, the information processing apparatus 100 periodically receives the traffic information from the traffic management apparatus 203. The traffic information indicates, for example, a road condition. The road condition is, for example, occurrence of a traffic jam, occurrence of a traffic accident, start of road construction, start of street closure, or the like. Next, description will be moved onto FIG. 11.

In FIG. 11, the information processing apparatus 100 detects a trigger for redrawing up the delivery plan on the basis of the current location of each delivery vehicle 1001 and the traffic information. For example, the information processing apparatus 100 detects the determination that there is a moving route on which the delivery vehicle 1001 can arrive at the delivery destination 1100 earlier than the current moving route, as the trigger for redrawing up the delivery plan. Specifically, as illustrated in FIG. 11, the information processing apparatus 100 detects the determination that there is a moving route 1102 on which the delivery vehicle 1001 can arrive at the delivery destination 1100 earlier than a current moving route 1101, as the trigger for redrawing up the delivery plan.

Furthermore, the information processing apparatus 100 detects the determination that, for example, it is more favorable that a certain delivery vehicle 1001 goes to the delivery destination 1100 than another delivery vehicle 1001 going to the delivery destination 1100, as the trigger for redrawing up the delivery plan. Specifically, as illustrated in FIG. 11, the information processing apparatus 100 determines whether it is more favorable that a certain delivery vehicle 1001 goes to the delivery destination 1100 on a moving route 1103 than another delivery vehicle 1001 going to the delivery destination 1100 on a moving route 1101. The information processing apparatus 100 detects the determination that it is more favorable that one delivery vehicle 1001 goes to the delivery destination 1100 on the moving route 1103, as the trigger for redrawing up the delivery plan.

Furthermore, the information processing apparatus 100 detects the determination that, for example, there is an addition of the delivery destination 1100, a decrease in the delivery destination 1100, a change in the restriction on the delivery time frame, or the like, as the trigger for redrawing up the delivery plan. Specifically, the information processing apparatus 100 determines whether there is an addition of the delivery destination 1100, a decrease in the delivery destination 1100, a change in the restriction on the delivery time frame, or the like, due to a redelivery request by a recipient corresponding to the delivery destination, or the like.

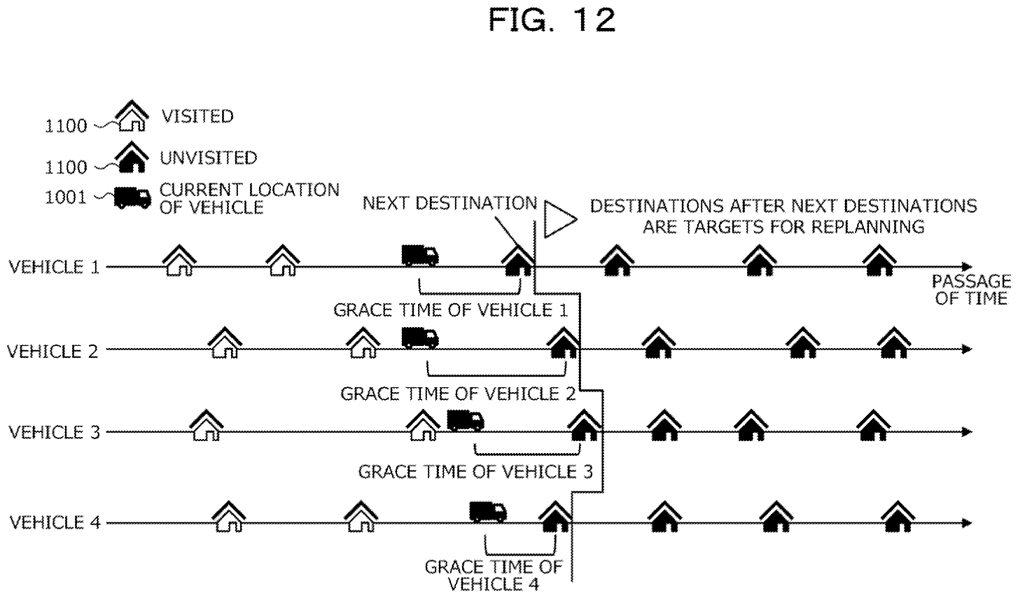

Furthermore, for example, the information processing apparatus 100 detects the determination that a scheduled point of time when the delivery vehicle 1001 arrives at the delivery destination 1100 does not satisfy the restriction on the delivery time frame, as the trigger for redrawing up the delivery plan. Here, it is assumed that the information processing apparatus 100 has detected the trigger for redrawing up the delivery plan. Next, description will be moved onto FIG. 12.

In FIG. 12, each of the delivery vehicles 1001 is in motion. The delivery vehicles 1001 are, for example, a vehicle 1, a vehicle 2, a vehicle 3, and a vehicle 4. A plurality of delivery destinations 1100 planned to be visited by each delivery vehicle 1001 existing on the moving route of the delivery vehicle 1001 are illustrated on the time axis corresponding to the delivery vehicle 1001. In the example of FIG. 12, the white house marks indicate visited delivery destinations 1100 at the present moment. The black house marks indicate unvisited delivery destinations 1100 at the present moment.

The information processing apparatus 100 specifies the delivery destination 1100 planned to be visited later than the delivery destination 1100 planned to be visited next by each delivery vehicle 1001, as a candidate for the delivery destination 1100 for changing the visit plan when redrawing up the delivery plan. In other words, the information processing apparatus 100 does not set each delivery destination 1100 from the first starting point of each delivery vehicle 1001 to the delivery destination 1100 planned to be visited next by the delivery vehicle 1001 as the delivery destination 1100 for changing the visit plan when redrawing up the delivery plan.

The information processing apparatus 100 calculates the remaining time to when each delivery vehicle 1001 departs, after a visit, the delivery destination 1100 planned to be visited next, as a candidate for the grace time for redrawing up the delivery plan, on the basis of the average speed, the average staying time, and the like of each delivery vehicle 1001. The information processing apparatus 100 sets the minimum value of the calculated candidates as the grace time for redrawing up the delivery plan. The information processing apparatus 100 sets, for example, the calculated candidate for the vehicle 4 as the grace time for redrawing up the delivery plan.

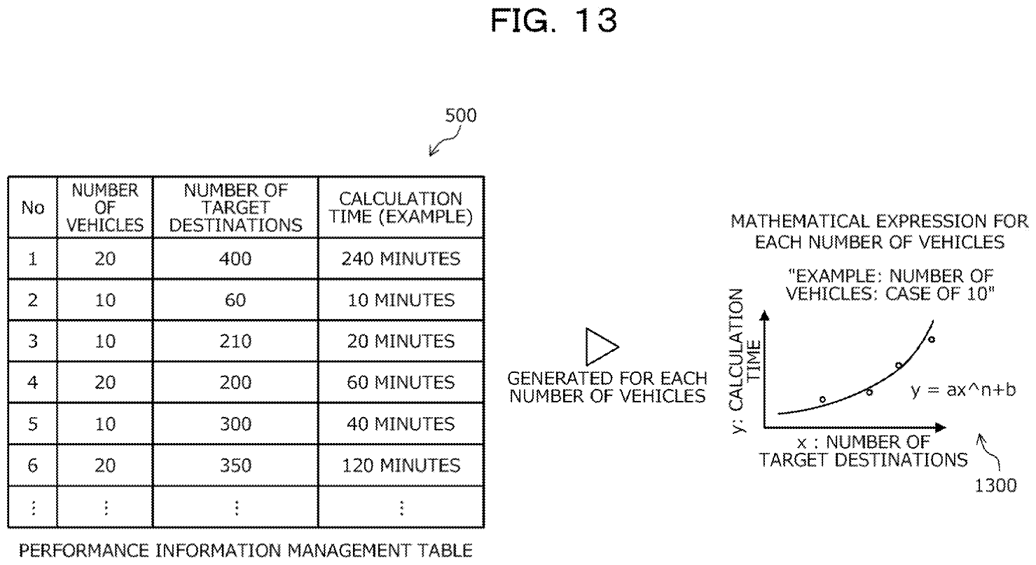

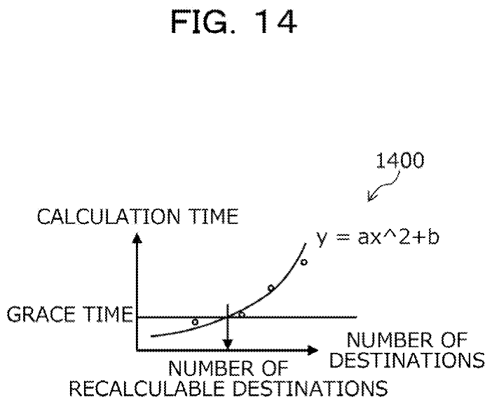

Thereby, even if the delivery vehicle 1001 continues to move and the delivery status continues to change, the information processing apparatus 100 can grasp by when the delivery plan should be redrawn up so as not to hinder the delivery operation after redrawing up the delivery plan. Next, description will be moved onto FIGS. 13 and 14.

In FIG. 13, the information processing apparatus 100 further narrows down the specified candidates for the delivery destinations 1100 so as to complete the redrawing up of the delivery plan within the grace time. The information processing apparatus 100 refers to, for example, the performance information management table 500, and generates a mathematical expression 1300 indicating the relationship between the number of target destinations and the calculation time for each number of vehicles. The mathematical expression is, for example, y=ax\hat{ }n+b. y is the calculation time. x is the number of target destinations. a is a coefficient. b is a coefficient. The information processing apparatus 100 may generate the mathematical expression 1300 in advance. At this time, if the performance information management table 500 is empty, the information processing apparatus 100 may provisionally calculate the calculation time and generate the mathematical expression 1300 in advance by assuming the number of vehicles and the number of target candidates and redrawing up a provisional delivery plan. Next, description will be moved onto FIG. 14.

In FIG. 14, the information processing apparatus 100 acquires a mathematical expression 1400 corresponding to the number of vehicles this time. The information processing apparatus 100 inputs the grace time to y of the mathematical expression 1400 and calculates the number=x of delivery destinations 1100 for which the visit plan is changeable. The information processing apparatus 100 selects the calculated number x of candidates for the delivery destination 1100 from the specified candidates for the delivery destination 1100, and determines the selected candidates as the delivery destinations 1100 for changing the visit plan. Thereby, the information processing apparatus 100 can determine the delivery destinations 1100 for changing the visit plan within a range not to hinder the delivery operation, and appropriately enables redrawing up of the delivery plan.

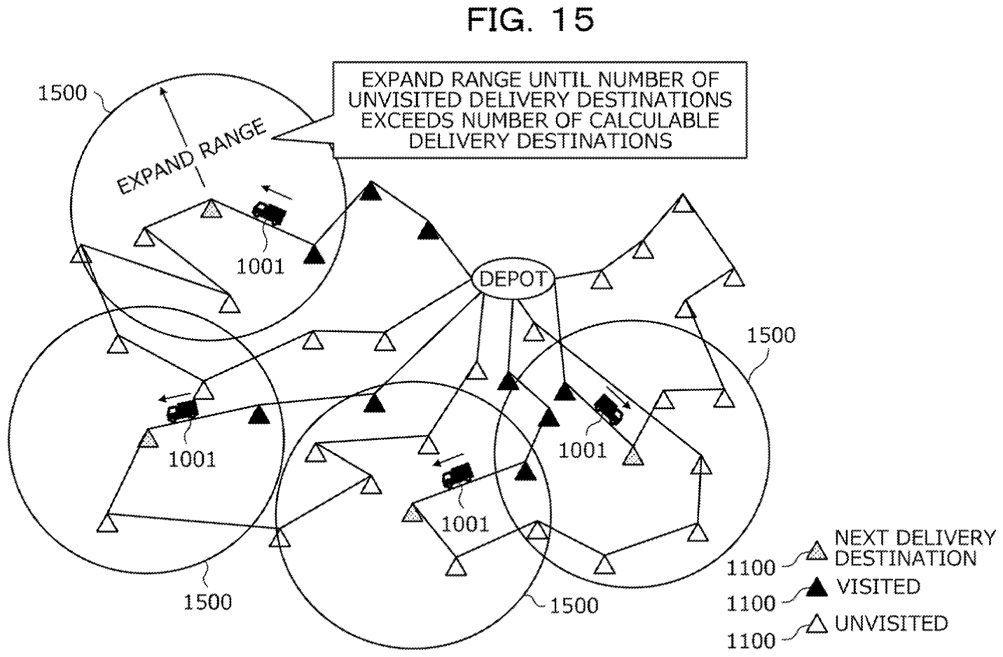

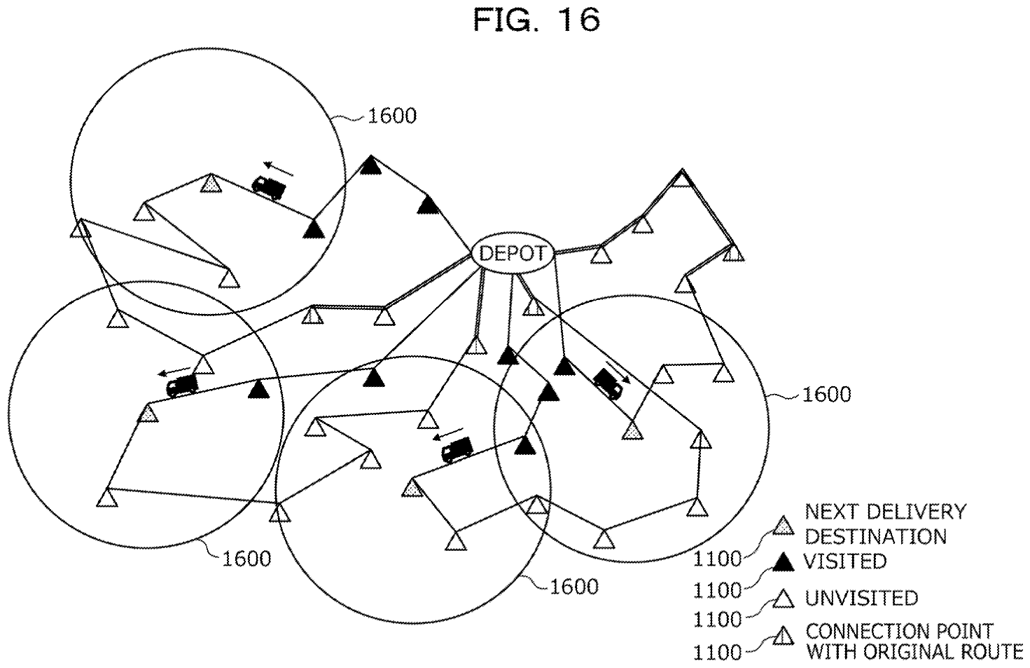

Next, moving onto the description of FIGS. 15 and 16, a specific example in which the information processing apparatus 100 determines the delivery destinations 1100 for changing the visit plan will be described. In FIG. 15, the information processing apparatus 100 sets an area 1500 centered on the delivery destination 1100 planned to be visited next by each delivery vehicle 1001.

The area 1500 is, for example, a range from the center to a fixed distance, and is a circular area. The area 1500 may be, for example, a movable range from the center in a fixed time. The size of the area 1500 may vary for each delivery vehicle 1001, for example.

The information processing apparatus 100 determines whether a number obtained by adding the number of unvisited delivery destinations 1100 included in each area 1500 is equal to or larger than the calculated number of delivery destinations 1100 for which the visit plan is changeable.

Here, the information processing apparatus 100 expands each area 1500 by a predetermined width when the number is not equal to or larger than the number of delivery destinations 1100 for which the visit plan is changeable. Then, the information processing apparatus 100 determines, for every expansion, whether the number obtained by adding the number of unvisited delivery destinations 1100 included in each area 1500 is equal to or larger than the calculated number of delivery destinations 1100 for which the visit plan is changeable. Meanwhile, the information processing apparatus 100 sets each area 1500 as a replanning range 1600 (illustrated in FIG. 16) when the number is equal to or larger than the number of delivery destinations 1100 for which the visit plan is changeable. Here, description will be moved onto FIG. 16.

In FIG. 16, the information processing apparatus 100 leaves a partial route not included in the set replanning range 1600 without change, of the moving route of each delivery vehicle 1001. In the example of FIG. 16, the partial routes not included in the replanning ranges 1600 are indicated by double lines. For example, the information processing apparatus 100 leaves the partial route not included in the replanning range 1600 without change by not changing the visit plan, for the unvisited delivery destinations 1100 not included in the replanning range 1600.

Meanwhile, the information processing apparatus 100 changes a partial route included in the set replanning range 1600, of the moving route of each delivery vehicle 1001. For example, the information processing apparatus 100 selects the undelivered delivery destinations 1100 by the calculated number of delivery destinations 1100 for which the visit plan is changeable, from among the undelivered delivery destinations 1100 not included in the replanning range 1600, and sets the selected undelivered delivery destinations as the delivery destinations for which the delivery schedule is to be actually changed. Then, the information processing apparatus 100 changes the partial route included in the replanning range 1600 by changing the delivery schedule of the set undelivered delivery destinations 1100, changes the moving route of each delivery vehicle 1001, and redraws up and adopts the delivery plan, for example.

At this time, the information processing apparatus 100 changes the partial route included in the changed replanning range 1600 such that the partial route included in the changed replanning range 1600 is connected with a starting point of the partial route not included in the set replanning range 1600 as a connection point. As a result, the information processing apparatus 100 can prevent the moving route of each delivery vehicle 1001 from being disconnected. Furthermore, even if the delivery vehicle 1001 continues to move and the delivery status continues to change, the information processing apparatus 100 can appropriately redraw up the delivery plan so as not to hinder the delivery operation and can determine the effective moving route of each delivery vehicle 1001.

Here, the information processing apparatus 100 may discard the redrawn-up delivery plan in a case where the moving route of each delivery vehicle 1001 has been changed and the grace time has elapsed when the delivery plan is redrawn up. Then, the information processing apparatus 100 continues to adopt the delivery plan currently being adopted. Thereby, the information processing apparatus 100 can appropriately perform the delivery work.

Furthermore, the information processing apparatus 100 may discard the redrawn-up delivery plan if the redrawn-up delivery plan does not satisfy predetermined restriction when redrawing up the delivery plan. The predetermined restriction is that, for example, each delivery vehicle 1001 visits each delivery destination 1100 within the same day. At this time, the information processing apparatus 100 may postpone the delivery schedule for any of the delivery destinations 1100 to the next day or later and redraw up the delivery plan. Thereby, the information processing apparatus 100 can appropriately perform the delivery work.

Furthermore, the information processing apparatus 100 may determine whether the redrawn-up delivery plan is more appropriate than the delivery plan being adopted, and may adopt the redrawn-up delivery plan in a case of determining the redrawn-up delivery plan is more appropriate. For example, the information processing apparatus 100 determines that the redrawn-up delivery plan is more appropriate than the delivery plan being adopted in a case where the delivery cost in the redrawn-up delivery plan is smaller than the delivery cost in the delivery plan being adopted. Thereby, the information processing apparatus 100 can adopt an appropriate delivery plan and can reduce the delivery cost.

Here, the case in which the information processing apparatus 100 sets the minimum value of the remaining time to when the delivery vehicle 1001 departs, after a visit, the delivery destination 1100 planned to be visited next, as the grace time, has been described. However, the embodiment is not limited to the case. For example, there may be a case in which the information processing apparatus 100 sets a minimum value of the remaining time to when the delivery vehicle 1001 departs, after a visit, the delivery destination 1100 planned to be visited n points later, as the grace time.

Specifically, the information processing apparatus 100 determines whether the minimum value of the remaining time to when the delivery vehicle 1001 departs, after a visit, the delivery destination 1100 planned to be visited next, is equal to or less than a threshold value. Then, when determining that the minimum value is equal to or less than the threshold value, the information processing apparatus 100 sets the minimum value of the remaining time to when the delivery vehicle 1001 departs, after a visit, the delivery destination 1100 planned to be visited n points later, as the grace time. Thereby, the information processing apparatus 100 can have a relatively long grace time and can easily redraw up the delivery plan.

Specifically, the information processing apparatus 100 determines whether the number of delivery destinations 1100 for which the visit plan becomes changeable in a case of assuming that the minimum value of the remaining time to when the delivery vehicle 1001 departs, after a visit, the delivery destination 1100 planned to be visited next as the grace time, is equal to or less than a threshold value. The threshold value is, for example, 0. Then, when determining that the minimum value is equal to or less than the threshold value, the information processing apparatus 100 sets the minimum value of the remaining time to when the delivery vehicle 1001 departs, after a visit, the delivery destination 1100 planned to be visited n points later, as the grace time. Thereby, the information processing apparatus 100 can have a relatively long grace time and can easily redraw up the delivery plan.

Furthermore, for example, when calculating the remaining time to when each delivery vehicle 1001 departs, after a visit, the delivery destination 1100 planned to be visited n points later, the information processing apparatus 100 may variably set the n for each delivery vehicle 1001.

(Overall Processing Procedure in First Operation Example)

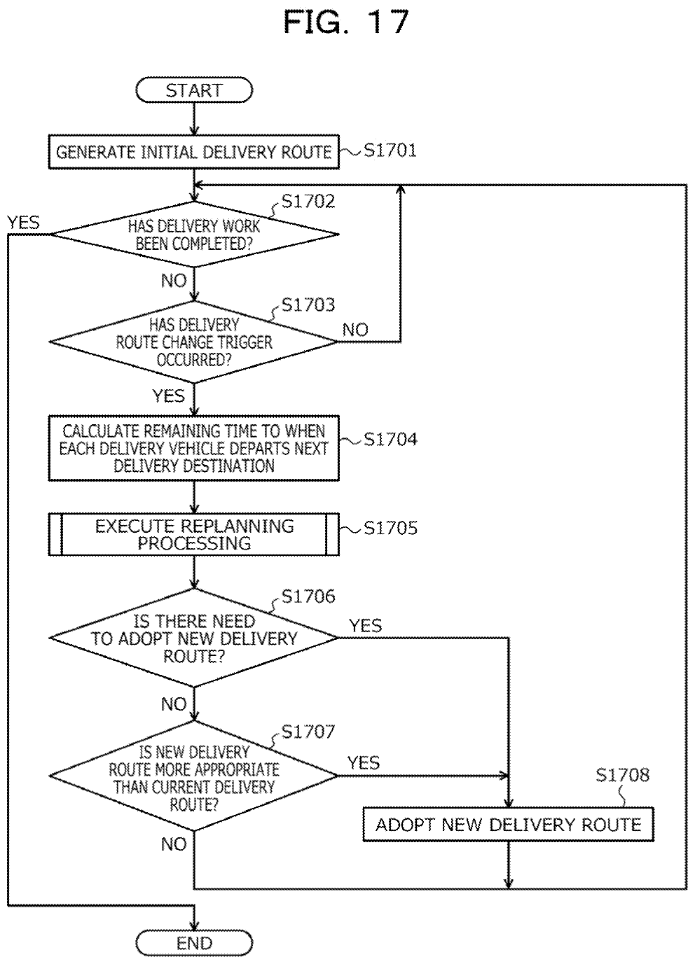

Next, one example of an overall processing procedure in the first operation example executed by the information processing apparatus 100 will be described with reference to FIG. 17. The overall processing is implemented by, for example, the CPU 401 illustrated in FIG. 4, the storage area such as the memory 402 or the recording medium 405, and the network I/F 403.

FIG. 17 is a flowchart illustrating one example of an overall processing procedure in the first operation example. In FIG. 17, the information processing apparatus 100 generates an initial delivery route for each delivery vehicle 1001 and adopts the generated delivery route for each delivery vehicle 1001 (step S1701). Here, the information processing apparatus 100 transmits the adopted delivery route for each delivery vehicle 1001 to the on-board apparatus 204 of the delivery vehicle 1001.

Next, the information processing apparatus 100 determines whether the delivery work has been completed (step S1702). Here, in a case where the delivery work has been completed (step S1702: Yes), the information processing apparatus 100 terminates the overall processing. On the other hand, in a case where the delivery work has not been completed (step S1702: No), the information processing apparatus 100 proceeds to the processing of step S1703.

In step S1703, the information processing apparatus 100 determines whether the change trigger has occurred, which is an event to change the delivery route being adopted for at least one of the delivery vehicles 1001 (step S1703). Herein, in a case where the change trigger has not occurred (step S1703: No), the information processing apparatus 100 returns to the processing of step S1702. On the other hand, in a case where the change trigger has occurred (step S1703: Yes), the information processing apparatus 100 proceeds to the processing of step S1704.

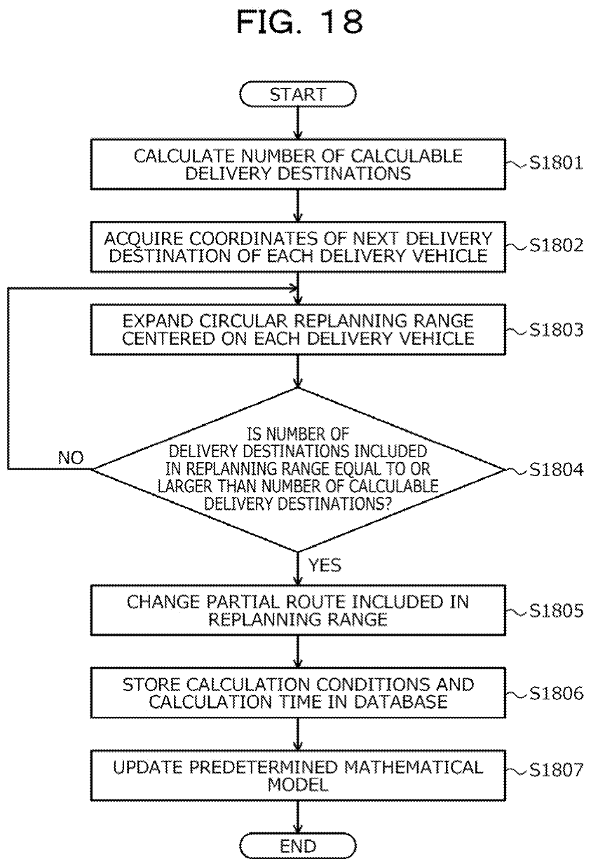

In step S1704, the information processing apparatus 100 calculates the remaining time to when each delivery vehicle 1001 departs the next delivery destination 1100 on the basis of the average speed of each delivery vehicle 1001 and the road condition, and sets the remaining time as the grace time (step S1704). Next, the information processing apparatus 100 executes replanning processing to be described below with reference to FIG. 18 to generate a new delivery route for each delivery vehicle 1001 (step S1705).

Then, the information processing apparatus 100 determines whether there is a need to adopt the generated new delivery route for each delivery vehicle 1001 (step S1706). Here, in a case where there is no need for adoption (step S1706: No), the information processing apparatus 100 proceeds to the processing of step S1707. On the other hand, in a case where there is a need for adoption (step S1706: Yes), the information processing apparatus 100 proceeds to the processing of step S1708.

In step S1707, the information processing apparatus 100 determines whether the generated new delivery route for each delivery vehicle 1001 is more appropriate than the current delivery route (step S1707). Here, in a case where the generated new delivery route is not more appropriate than the current delivery route (step S1707: No), the information processing apparatus 100 returns to the processing of step S1702. On the other hand, in a case where the generated new delivery route is more appropriate than the current delivery route (step S1707: Yes), the information processing apparatus 100 proceeds to the processing of step S1708.

In step S1708, the information processing apparatus 100 adopts the generated new delivery route for each delivery vehicle 1001 (step S1708). Here, the information processing apparatus 100 transmits the adopted new delivery route for each delivery vehicle 1001 to the on-board apparatus 204 of the delivery vehicle 1001. Then, the information processing apparatus 100 returns to the processing of step S1702.

(Replanning Processing Procedure in First Operation Example)

Next, one example of a replanning processing procedure in the first operation example executed by the information processing apparatus 100 will be described with reference to FIG. 18. The replanning processing is implemented by, for example, the CPU 401, the storage area such as the memory 402 or the recording medium 405, and the network I/F 403 illustrated in FIG. 4.

FIG. 18 is a flowchart illustrating one example of the replanning processing procedure in the first operation example. In FIG. 18, the information processing apparatus 100 calculates the number of calculable delivery destinations 1100 by inputting the grace time into a predetermined mathematical model (step S1801).

Next, the information processing apparatus 100 acquires the coordinates of the next delivery destination 1100 of each delivery vehicle 1001 (step S1802). Then, the information processing apparatus 100 expands a circular replanning range centered on each delivery vehicle 1001 (step S1803).

Next, the information processing apparatus 100 determines whether the number of delivery destinations 1100 included in the replanning range is equal to or larger than the number of calculatable delivery destinations 1100 (step S1804). Here, in a case where the number of delivery destinations is less than the number of calculable delivery destinations 1100 (step S1804: No), the information processing apparatus 100 returns to the processing of step S1803. On the other hand, in a case where the number of delivery destinations is equal to or larger than the number of calculable delivery destinations 1100 (step S1804: Yes), the information processing apparatus 100 proceeds to the processing of step S1805.

In step S1805, the information processing apparatus 100 changes the partial route included in the replanning range while maintaining the partial route off the replanning range in the adopted delivery route for each delivery vehicle 1001 (step S1805). Specifically, the information processing apparatus 100 selects as many delivery destinations 1100 as the number of calculatable delivery destinations 1100 from the undelivered delivery destinations 1100 included in the replanning range. Specifically, the information processing apparatus 100 changes the partial route included in the replanning range by changing the visit plan for the selected delivery destination 1100.

Next, the information processing apparatus 100 stores calculation conditions and the calculation time in a database (step S1806). The database is, for example, the performance information management table 500. Then, the information processing apparatus 100 updates the predetermined mathematical model (step S1807). Thereafter, the information processing apparatus 100 terminates the replanning processing.

Here, the information processing apparatus 100 may swap some steps in the processing order in each of the flowcharts in FIGS. 17 and 18 and execute the processing. For example, steps S1706 and S1707 may be swapped in the processing order. Furthermore, the information processing apparatus 100 may omit the processing in some steps in each of the flowcharts in FIGS. 17 and 18. For example, the processing of steps S1706 and S1707 can be omitted.

(Second Operation Example of Information Processing Apparatus 100)

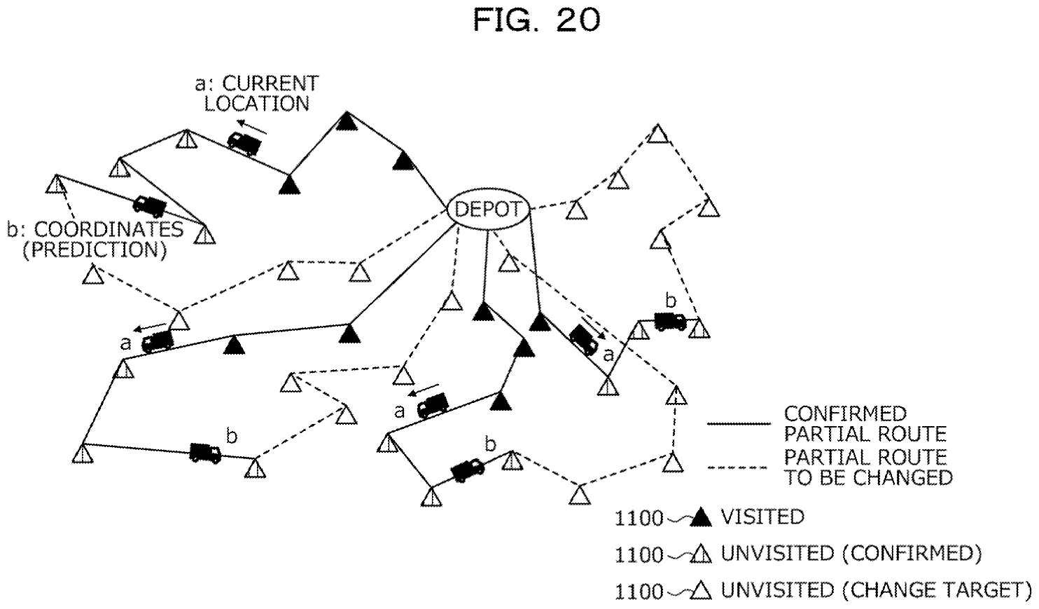

Next, a second operation example of the information processing apparatus 100 will be described with reference to FIGS. 19 and 20.

FIGS. 19 and 20 are explanatory diagrams illustrating a second operation example of the information processing apparatus 100. Similar to the first operation example, the information processing apparatus 100 draws up and adopts the initial delivery plan by setting all of delivery destinations 1100 as destinations planned to be visited and determining the initial moving route of each delivery vehicle 1001. Similar to the first operation example, the information processing apparatus 100 transmits the initial moving route of each delivery vehicle 1001 to the on-board apparatus 204 mounted on the delivery vehicle 1001.

Similar to the first operation example, while each delivery vehicle 1001 is moving, the information processing apparatus 100 periodically receives the progress information including the current location of the delivery vehicle 1001 and the visit history of the delivery vehicle 1001 from each delivery vehicle 1001. Similar to the first operation example, the information processing apparatus 100 periodically receives the traffic information from the traffic management apparatus 203. Similar to the first operation example, the information processing apparatus 100 detects a trigger for redrawing up the delivery plan on the basis of the current location of each delivery vehicle 1001 and the traffic information.

In FIG. 19, each of the delivery vehicles 1001 is in motion. In the example of FIG. 19, the white house mark indicates the visited delivery destination 1100. The black house mark indicates the unvisited delivery destination 1100.

The information processing apparatus 100 assumes that the delivery destination 1100 unvisited by any delivery vehicle 1001 is set as the delivery destination 1100 for changing the visit plan, and estimates the time required for redrawing up the delivery plan. The information processing apparatus 100 estimates the time required for redrawing up the delivery plan, using, for example, the mathematical expression 1300 illustrated in FIG. 13. Specifically, the information processing apparatus 100 calculates the time required=y by substituting the set number=x of delivery destinations 1100 into the mathematical expression 1300 illustrated in FIG. 13.

The information processing apparatus 100 estimates the coordinates of each delivery vehicle 1001, assuming that the calculated time required has elapsed. In the case of assuming that the calculated time required has elapsed on the basis of the estimated coordinates of each delivery vehicle 1001, the information processing apparatus 100 specifies the visited delivery destination 1100 and the delivery destination 1100 planned to be visited next by each delivery vehicle 1001. Thereby, assuming that drawing up of the delivery plan is started from the present moment, the information processing apparatus 100 can specify the visited delivery destination 1100 and the delivery destination 1100 planned to be visited next by each delivery vehicle 1001 when redrawing up is completed. In other words, the information processing apparatus 100 can specify the destination that is not useful as a destination for changing the visit plan and is more favorable not to be a destination for changing the visit plan.

The information processing apparatus 100 determines the destination unvisited by any delivery vehicle 1001, other than the specified destinations, as the delivery destination 1100 for changing the visit plan when redrawing up the delivery plan. Thereby, even if the delivery vehicle 1001 continues to move and the delivery status continues to change, the information processing apparatus 100 can redraw up the delivery plan within a range not to hinder the delivery operation. Next, moving onto the description of FIG. 20, a specific example in which the information processing apparatus 100 determines the delivery destinations 1100 for changing the visit plan will be described.

In FIG. 20, the information processing apparatus 100 acquires a current location a of each delivery vehicle 1001. The information processing apparatus 100 assumes that the delivery destination 1100 unvisited by any delivery vehicle 1001 is set as the delivery destination 1100 for changing the visit plan, and estimates the time required for redrawing up the delivery plan. The information processing apparatus 100 specifies coordinates b of each delivery vehicle 1001 after the time required has elapsed, on the basis of the average speed and the average staying time of each delivery vehicle 1001.

The information processing apparatus 100 specifies the delivery destination 1100 planned to be visited next by each delivery vehicle 1001 after the time required has elapsed, on the basis of the coordinates b of the delivery vehicle 1001. Then, the information processing apparatus 100 sets a partial route from the first starting point of each delivery vehicle 1001 to the specified delivery destination 1100 planned to be visited next by the delivery vehicle 1001, of the moving route of the delivery vehicle 1001, as a confirmed partial route, and leaves the confirmed partial route without change. The first starting point is, for example, a depot. In the example of FIG. 20, the confirmed partial routes are illustrated by the solid lines. For example, the information processing apparatus 100 leaves the confirmed partial route without change by not changing the visit plan of the unvisited delivery destination 1100 on the confirmed partial route.

Meanwhile, the information processing apparatus 100 sets a partial route after the specified delivery destination 1100 planned to be visited next by each delivery vehicle 1001, of the moving route of the delivery vehicle 1001, as the moving route to be processed. For example, the information processing apparatus 100 changes the partial route to be processed by changing the visit plan of the unvisited delivery destination 1100 on the partial route to be processed, changes the moving route of each delivery vehicle 1001, and redraws up and adopts the delivery plan. Thereby, even if the delivery vehicle 1001 continues to move and the delivery status continues to change, the information processing apparatus 100 can appropriately redraw up the delivery plan so as not to hinder the delivery operation and can determine the effective moving route of each delivery vehicle 1001.

Here, the information processing apparatus 100 may determine whether the redrawn-up delivery plan is more appropriate than the delivery plan being adopted, and may adopt the redrawn-up delivery plan in a case of determining the redrawn-up delivery plan is more appropriate. For example, the information processing apparatus 100 determines that the redrawn-up delivery plan is more appropriate than the delivery plan being adopted in a case where the delivery cost in the redrawn-up delivery plan is smaller than the delivery cost in the delivery plan being adopted. Thereby, the information processing apparatus 100 can adopt an appropriate delivery plan and can reduce the delivery cost.

(Overall Processing Procedure in Second Operation Example)

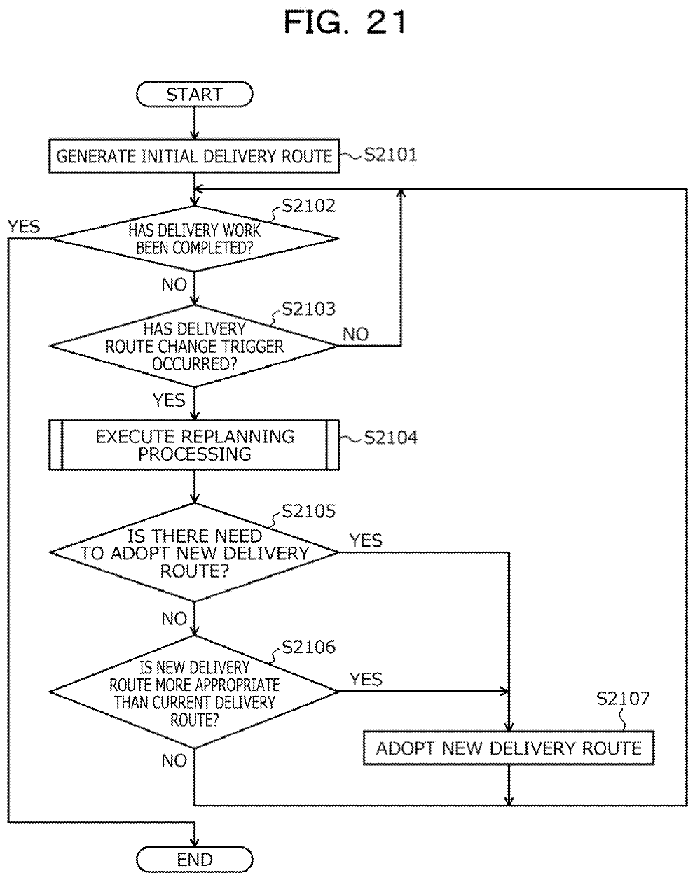

Next, one example of an overall processing procedure in the second operation example executed by the information processing apparatus 100 will be described with reference to FIG. 21. The overall processing is implemented by, for example, the CPU 401 illustrated in FIG. 4, the storage area such as the memory 402 or the recording medium 405, and the network I/F 403.

FIG. 21 is a flowchart illustrating one example of an overall processing procedure in the second operation example. In FIG. 21, the information processing apparatus 100 generates an initial delivery route for each delivery vehicle and adopts the generated delivery route for each delivery vehicle (step S2101). Here, the information processing apparatus 100 transmits the adopted delivery route for each delivery vehicle to the on-board apparatus 204 of the delivery vehicle.

Next, the information processing apparatus 100 determines whether the delivery work has been completed (step S2102). Here, in a case where the delivery work has been completed (step S2102: Yes), the information processing apparatus 100 terminates the overall processing. On the other hand, in a case where the delivery work has not been completed (step S2102: No), the information processing apparatus 100 proceeds to the processing of step S2103.

In step S2103, the information processing apparatus 100 determines whether the change trigger of the delivery route being adopted for at least one of the delivery vehicles has occurred (step S2103). Here, in a case where the change trigger has not occurred (step S2103: No), the information processing apparatus 100 returns to the processing of step S2102. On the other hand, in a case where the change trigger has occurred (step S2103: Yes), the information processing apparatus 100 proceeds to the processing of step S2104.

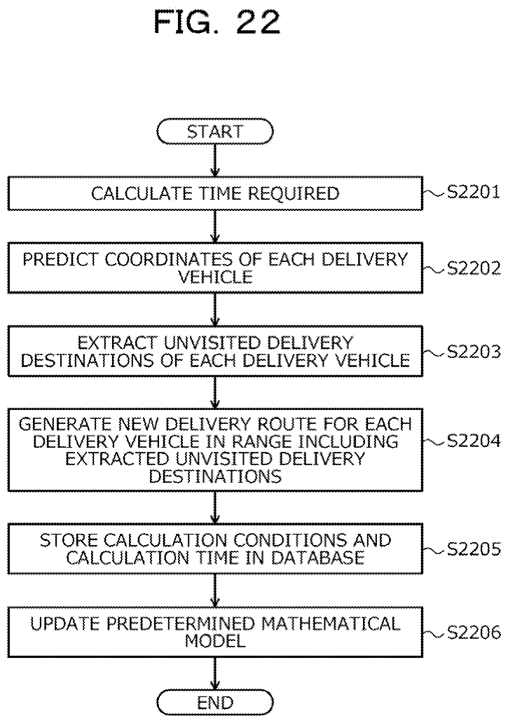

In step S2104, the information processing apparatus 100 executes the replanning processing to be described below with reference to FIG. 22 to generate a new delivery route for each delivery vehicle (step S2104).

Next, the information processing apparatus 100 determines whether there is a need to adopt the generated new delivery route for each delivery vehicle (step S2105). Here, in a case where there is no need for adoption (step S2105: No), the information processing apparatus 100 proceeds to the processing of step S2106. On the other hand, in a case where there is a need for adoption (step S2105: Yes), the information processing apparatus 100 proceeds to the processing of step S2107.

In step S2106, the information processing apparatus 100 determines whether the generated new delivery route for each delivery vehicle is more appropriate than the current delivery route (step S2106). Here, in a case where the generated new delivery route is not more appropriate than the current delivery route (step S2106: No), the information processing apparatus 100 returns to the processing of step S2102. On the other hand, in a case where the generated new delivery route is more appropriate than the current delivery route (step S2106: Yes), the information processing apparatus 100 proceeds to the processing of step S2107.

In step S2107, the information processing apparatus 100 adopts the generated new delivery route for each delivery vehicle, and transmits the adopted new delivery route for each delivery vehicle to the on-board apparatus 204 of the delivery vehicle. (Step S2107). Then, the information processing apparatus 100 returns to the processing of step S2102.

(Replanning Processing Procedure in Second Operation Example)

Next, one example of a replanning processing procedure in the second operation example executed by the information processing apparatus 100 will be described with reference to FIG. 22. The replanning processing is implemented by, for example, the CPU 401, the storage area such as the memory 402 or the recording medium 405, and the network I/F 403 illustrated in FIG. 4.

FIG. 22 is a flowchart illustrating one example of the replanning processing procedure in the second operation example. In FIG. 22, the information processing apparatus 100 calculates the time required on the basis of the number of unvisited delivery destinations 1100 by using a predetermined mathematical model (step S2201).

Next, the information processing apparatus 100 predicts the coordinates of each delivery vehicle of a case where the time required is assumed to have elapsed (step S2202). Then, the information processing apparatus 100 extracts the unvisited delivery destination 1100 of each delivery vehicle of the case where the time required is assumed to have elapsed on the basis of the predicted coordinates of each delivery vehicle (step S2203). Thereafter, the information processing apparatus 100 generates a new delivery route for each delivery vehicle within the range including the extracted unvisited delivery destinations 1100 (step S2204).

Next, the information processing apparatus 100 stores calculation conditions and the calculation time in a database (step S2205). Then, the information processing apparatus 100 updates the predetermined mathematical model (step S2206). Thereafter, the information processing apparatus 100 terminates the replanning processing.

Here, the information processing apparatus 100 may swap some steps in the processing order in each of the flowcharts in FIGS. 21 and 22 and execute the processing. For example, steps S2106 and S2107 may be swapped in the processing order. Furthermore, the information processing apparatus 100 may omit the processing in some steps in each of the flowcharts in FIGS. 21 and 22. For example, the processing of steps S2106 and S2107 can be omitted.

As described above, according to the information processing apparatus 100, it is possible to detect to change the moving route that passes through two or more destinations planned to be visited by each mobile body, of a plurality of mobile bodies that visits a plurality of destinations in a distributed manner. According to the information processing apparatus 100, when detecting to change the moving route of each mobile body, it is possible to acquire the remaining time to when the mobile body visits one destination of destinations unvisited by the mobile body, the unvisited destinations existing on the moving route of each mobile body. Alternatively, according to the information processing apparatus 100, when detecting to change the moving route of each mobile body, it is possible to acquire the remaining time to when the mobile body departs, after a visit, one destination of destinations unvisited by the mobile body, the unvisited destinations existing on the moving route of the mobile body. According to the information processing apparatus 100, it is possible to determine the destination for which the visit plan is to be changed, among the destinations unvisited by any mobile body of the plurality of mobile bodies included in the plurality of destinations on the basis of the acquired remaining time. According to the information processing apparatus 100, it is possible to change the moving route of each mobile body on the basis of the determined destination. Thereby, the information processing apparatus 100 can prevent the changed moving route from not matching the moving status of the mobile body and becoming an ineffective moving route.

According to the information processing apparatus 100, it is possible to specify the number of destinations for which the visit plan is changeable in the acquired remaining time, among the plurality of destinations, using a predetermined model. According to the information processing apparatus 100, it is possible to determine the destination for which the visit plan is to be changed, among the destinations unvisited by any mobile body of the plurality of mobile bodies included in the plurality of destinations on the basis of the specified number. As a result, the information processing apparatus 100 can accurately and easily specify the number of destinations for which the visit plan is changeable in the remaining time.

According to the information processing apparatus 100, it is possible to select the specified number of unvisited destinations included in the area with the destination planned to be visited next by each mobile body as the reference point, among the destinations unvisited by the mobile body, the destinations existing on the moving route of the mobile body. According to the information processing apparatus 100, it is possible to determine the selected unvisited destination as the destination for which the visit plan is to be changed. Thereby, the information processing apparatus 100 can easily complete the change in the visit plan for the destination in the remaining time.

According to the information processing apparatus 100, it is possible to select the specified number of unvisited destinations included in the area with one starting point of each mobile body as the reference point, among the destinations unvisited by the mobile body, the destinations existing on the moving route of the mobile body. According to the information processing apparatus 100, it is possible to determine the selected unvisited destination as the destination for which the visit plan is to be changed. Thereby, the information processing apparatus 100 can easily complete the change in the visit plan for the destination in the remaining time.

According to the information processing apparatus 100, it is possible to set the area on the basis of the linear distance from the reference point. Thereby, the information processing apparatus 100 enables determination of the destination for changing the visit plan so that the changed moving route is likely to be shortened in consideration of the linear distance from the reference point.

According to the information processing apparatus 100, it is possible to set the area on the basis of the travel time from the reference point. Thereby, the information processing apparatus 100 enables determination of the destination for changing the visit plan so that the changed moving route is likely to be shortened in consideration of the travel time from the reference point.

According to the information processing apparatus 100, it is possible to acquire the remaining time to when each mobile body visits, or the remaining time to when the mobile body departs, after a visit, the destination planned to be visited next by the mobile body. Thereby, the information processing apparatus 100 can change the moving route of each mobile body before each mobile body visits, or departs, after a visit, the destination planned to be visited next.

According to the information processing apparatus 100, it is possible to determine the destination for which the visit plan is to be changed, among the destinations unvisited by any mobile body of the plurality of mobile bodies included in the plurality of destinations on the basis of the minimum value of the acquired remaining time. Thereby, the information processing apparatus 100 can prevent the moving route of each mobile body from becoming an ineffective moving route in consideration of the minimum value of the remaining time.

According to the information processing apparatus 100, when detecting to change the moving route of each mobile body, it is possible to acquire the time required for changing the moving route of each mobile body on the basis of the destination unvisited by any mobile body of the plurality of mobile bodies, among the plurality of destinations. According to the information processing apparatus 100, it is possible to determine the destination for which the visit plan is to be changed, among the destinations unvisited by any mobile body of the plurality of mobile bodies included in the plurality of destinations on the basis of the acquired time required. According to the information processing apparatus 100, it is possible to change the moving route of each mobile body on the basis of the determined destination. Thereby, the information processing apparatus 100 can prevent the changed moving route from not matching the moving status of the mobile body and becoming an ineffective moving route.

According to the information processing apparatus 100, when detecting to change the moving route of each mobile body, it is possible to acquire the time required for changing the moving route of each mobile body on the basis of the destination unvisited by any mobile body, using a predetermined model. Thereby, the information processing apparatus 100 can easily acquire the time required with high accuracy.

According to the information processing apparatus 100, the remaining destinations excluding the visitable destinations in the acquired time required and the destinations planned to be visited next after the acquired time required, among the destinations unvisited by any mobile body, can be determined as the destinations for which the visit plan is to be changed. Thereby, the information processing apparatus 100 can easily prevent the moving route of each mobile body from becoming an ineffective moving route.

Note that the change method described in the present embodiment may be implemented by executing a prepared program on a computer such as a personal computer (PC) or a workstation. The change program described in the present embodiment is executed by being recorded on a computer-readable recording medium and being read from the recording medium by the computer. The recording medium is a hard disk, a flexible disk, a compact disc (CD)-ROM, a magneto optical disc (MO), a digital versatile disc (DVD), or the like. Furthermore, the change program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a moving route change program for causing a computer to execute a process comprising:
detecting to change a moving route that passes through two or more destinations planned to be visited by each mobile body, of a plurality of mobile bodies that visits a plurality of destinations in a distributed manner;
when detecting to change the moving route of the each mobile body, acquiring a remaining time to when the each mobile body visits, or a remaining time to when the each mobile body departs, after a visit, one destination unvisited by the each mobile body which exists on the moving route of the each mobile body;
determining a destination as a target that changes a visit plan, of destinations unvisited by any mobile body of the plurality of mobile bodies, on a basis of the acquired remaining time; and
changing the moving route of the each mobile body on a basis of the determined destination.

2. The non-transitory computer-readable recording medium according to claim 1, wherein the determining includes
specifying a number of destinations for which the visit plan is changeable in the acquired remaining time, among the plurality of destinations, using a model that enables calculation of a processing time for changing the visit plan according to the number of mobile bodies included in the plurality of mobile bodies and the number of destinations for which the visit plan is to be changed among the plurality of destinations, and
determining the destination as the target that changes the visit plan, among the destinations unvisited by any mobile body of the plurality of mobile bodies, on a basis of the specified number.

3. The non-transitory computer-readable recording medium according to claim 2, wherein the determining further includes
selecting the specified number of unvisited destinations included in an area with a destination planned to be visited next by the each mobile body as a reference point, among the destinations unvisited by the each mobile body which exist on the moving route of the each mobile body, and determining the selected destinations as targets that change a visit plan.

4. The non-transitory computer-readable recording medium according to claim 2, wherein the determining further includes
selecting the specified number of unvisited destinations included in an area with a starting point of the each mobile body as a reference point, among the destinations unvisited by the each mobile body which exist on the moving route of the each mobile body, and determining the selected destinations as targets that change a visit plan.

5. The non-transitory computer-readable recording medium according to claim 3, wherein the area is set on a basis of a linear distance from the reference point.

6. The non-transitory computer-readable recording medium according to claim 3, wherein the area is set on a basis of a travel time from the reference point.

7. The non-transitory computer-readable recording medium according to claim 1, wherein the acquiring includes
acquiring the remaining time to when the each mobile body visits, or the remaining time to when the each mobile body departs, after a visit, a destination planned to be visited next by the each mobile body, among the destinations unvisited by the each mobile body which exist on the moving route of the each mobile body.

8. The non-transitory computer-readable recording medium according to claim 1, wherein
the destination as the target that changes the visit plan, of the destinations unvisited by any mobile body of the plurality of mobile bodies and included in the plurality of destinations, is determined on a basis of a minimum value of the acquired remaining times.

9. The non-transitory computer-readable recording medium according to claim 1, the process further comprising:
when detecting to change the moving route of each mobile body, acquiring a time required for changing the moving route of the each mobile body, on a basis of the destinations unvisited by any mobile body of the plurality of mobile bodies, among the plurality of destinations;
determining the destination as a target that changes a visit plan, among the destinations unvisited by any mobile body of the plurality of mobile bodies, on a basis of the acquired time required; and
changing the moving route of the each mobile body on a basis of the determined destination.

10. A moving route change method performed by a computer, the method comprising:
detecting to change a moving route that passes through two or more destinations planned to be visited by each mobile body, of a plurality of mobile bodies that visits a plurality of destinations in a distributed manner;
when detecting to change the moving route of the each mobile body, acquiring a remaining time to when the each mobile body visits, or a remaining time to when the each mobile body departs, after a visit, one destination unvisited by the each mobile body which exists on the moving route of the each mobile body;
determining a destination as a target that changes a visit plan, of destinations unvisited by any mobile body of the plurality of mobile bodies, on a basis of the acquired remaining time; and
changing the moving route of the each mobile body on a basis of the determined destination.

11. An information processing apparatus comprising:
a memory, and
a processor coupled to the memory and configured to:
detect to change a moving route that passes through two or more destinations planned to be visited by each mobile body, of a plurality of mobile bodies that visits a plurality of destinations in a distributed manner;
when to change the moving route of the each mobile body is detected, acquire a remaining time to when the each mobile body visits, or a remaining time to when the each mobile body departs, after a visit, one destination unvisited by the each mobile body which exists on the moving route of the each mobile body;
determine a destination as a target that changes a visit plan, of destinations unvisited by any mobile body of the plurality of mobile bodies, on a basis of the acquired remaining time; and
change the moving route of the each mobile body on a basis of the determined destination.

12. A non-transitory computer-readable recording medium storing a moving route change program for causing a computer to execute a process comprising:
detecting to change a moving route that passes through two or more destinations planned to be visited by each mobile body, of a plurality of mobile bodies that visits a plurality of destinations in a distributed manner;
when detecting to change a moving route of the each mobile body, acquiring a time required for changing the moving route of the each mobile body, on a basis of destinations unvisited by any mobile body of the plurality of mobile bodies, among the plurality of destinations;
determining a destination as a target that changes a visit plan, among the destinations unvisited by any mobile body of the plurality of mobile bodies and included in the plurality of destinations, on a basis of the acquired time required; and
changing the moving route of the each mobile body on a basis of the determined destination.

13. The non-transitory computer-readable recording medium according to claim 12, wherein the acquiring includes
acquiring the time required for changing the moving route of the each mobile body, on a basis of the destinations unvisited by any mobile body of the plurality of mobile bodies, using a model that enables calculation of a processing time for change processing of changing the visit plan, according to the number of mobile bodies included in the plurality of mobile bodies, and the number of destinations for which the visit plan is to be changed among the plurality of destinations.

14. The non-transitory computer-readable recording medium according to claim 12, wherein the determining includes
determining one or more remaining destinations, excluding destinations visitable within the acquired time required and a destination planned to be visited next after the acquired time required, among the destinations unvisited by any mobile body of the plurality of mobile bodies, as the destination as the target that changes the visit plan.

15. A moving route change method performed by a computer, the method comprising:
detecting to change a moving route that passes through two or more destinations planned to be visited by each mobile body, of a plurality of mobile bodies that visits a plurality of destinations in a distributed manner;
when detecting to change a moving route of the each mobile body, acquiring a time required for changing the moving route of the each mobile body, on a basis of destinations unvisited by any mobile body of the plurality of mobile bodies, among the plurality of destinations;
determining a destination as a target that changes a visit plan, among the destinations unvisited by any mobile body of the plurality of mobile bodies and included in the plurality of destinations, on a basis of the acquired time required; and
changing the moving route of the each mobile body on a basis of the determined destination.

16. An information processing comprising:
a memory, and
a processor coupled to the memory and configured to:
detect to change a moving route that passes through two or more destinations planned to be visited by each mobile body, of a plurality of mobile bodies that visits a plurality of destinations in a distributed manner;
when to change a moving route of the each mobile body is detected, acquire a time required for changing the moving route of the each mobile body, on a basis of destinations unvisited by any mobile body of the plurality of mobile bodies, among the plurality of destinations;
determine a destination as a target that changes a visit plan, among the destinations unvisited by any mobile body of the plurality of mobile bodies and included in the plurality of destinations, on a basis of the acquired time required; and
changing the moving route of the each mobile body on a basis of the determined destination.
